(19) United States
(12) Patent Application Publication
(10) Pub. No.: US 2006/0194143 A1
(43) Pub. Date: Aug. 31, 2006

(54) Fluorine-containing polymerizable monomers, fluorine-containing polymer compounds, resist compositions using the same, and patterning process

(76) Inventors: Shinichi Sumida, Saitama (JP); Haruhiko Komoriya, Saitama (JP); Sunao Koga, Saitama (JP); Takeo Komata, Saitama (JP)

Correspondence Address: YOUNG & THOMPSON, 745 SOUTH 23RD STREET, 2ND FLOOR, ARLINGTON, VA, 22202, US

(21) Appl. No.: 11/064,818

(22) Filed: Feb. 25, 2005

(51) Int. Cl. G03C 1/76

(52) U.S. Cl. 430/270.1

(57) ABSTRACT

The present invention provides a fluorine-containing acrylate compound represented by general formula (1): 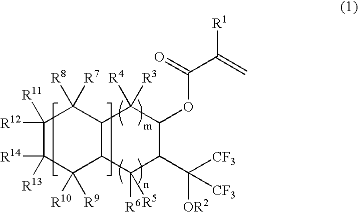
wherein R¹ is any one functional group of a hydrogen atom, a methyl group and a trifluoromethyl group; R² is a hydrogen atom or a straight-chain, branched or cyclic alkyl group having 1 to 25 carbon atoms, which may contain a fluorine atom, an oxygen atom, a nitrogen atom, a sulfur atom or a carbonyl bond at a part thereof; R³ to R¹⁴ are each a hydrogen atom or a straight-chain, branched or cyclic alkyl group having 1 to 25 carbon atoms, which may contain a fluorine atom, an oxygen atom, a nitrogen atom, a sulfur atom or a hydroxyl group at a part thereof; R³ and R⁵, R⁷ and R⁹, or two groups of R¹¹ to R¹⁴ may be combined with each other to form a ring as an alkylene group having 1 to 25 carbon atoms, which may contain an oxygen atom, a sulfur atom or a nitrogen atom at a part thereof; l is 0 or 1; and m and n each represents any integer of 0 to 4. Also further disclosed are a fluorine-containing polymer compound or a polymer or copolymer of the fluorine-containing acrylate compound, a resist composition using the fluorine-containing polymer compound, and a patterning process.

### FIELD OF THE INVENTION

The present invention relates to a fluorine-containing acrylate compound which is a novel fluorine-containing polymerizable monomer, a polymerized or copolymerized fluorine-containing polymer compound using the same, a resist composition and a patterning process, and particularly to a chemically amplified resist composition which have recently been actively studied and a patterning process.

### BACKGROUND OF THE INVENTION

With recent increases in integration and speed of LSIs, miniaturization of pattern rules has been required, and as one of procedures for achieving the miniaturization, it has been known to shorten the wavelength of an exposure light source used in patterning a resist. The i-ray (365 nm) from a high-pressure mercury lamp has hitherto been employed as an exposure light source for the production of semiconductor devices having a degree of integration of up to 64 M bits, and the KrF excimer laser beam (248 nm) instead of the i-ray for the production of semiconductor devices having a degree of integration of 256 M bits or more. Additionally, for the production of semiconductors having a degree of integration of 1 G bits or more, the use of the ArF excimer laser beam (193 nm) which is a light source having a shorter wavelength, and further, the use of the F₂ excimer laser beam (157 nm) have recently been studied.

In ArF excimer laser lithography (193 nm), processing with a design rule of 0.13 μm or less has been expected. However, resins such as a novolak resin and a polyvinylphenol (aromatic) resin which have been used for the KrF excimer laser have very strong absorption in the vicinity of 193 nm, so that these resins cannot be used as a base resin for ArF resist. Then, acrylic resins and cycloolefinic resins have been studied in which an aromatic resin is substituted by an aliphatic resin for improvement in transparency and a cyclic compound is introduced for securement of etching resistance (patent documents 1 to 4). With respect to F₂ lithography (157 nm), miniaturization to 0.10 μm or less has been expected. However, it has been known that securement of transparency increasingly becomes difficult, and that base polymers for KrF and ArF cannot be used because of their strong absorption.

As polymers for F₂ resist, there have hitherto been reported a copolymer of t-butyl trifluoromethacrylate and 5-(2-hydroxy-2,2-bistrifluoromethyl)ethyl-2-norbornene, and a copolymer of t-butyl trifluoromethacrylate and 3-(2-hydroxy-2,2-bistrifluoromethyl)methylstyrene. However, these polymers have an absorbance of about 3, which is insufficient for patterning at an ordinary film thickness, and further improvement in transparency has been required (non-patent document 1). Recently, a highly transparent resin having an absorbance of 1 or less and excellent in substrate adhesion has been proposed. However, it has the disadvantage of the low rate of dissolution, so that investigations for overcoming this disadvantage have been conducted (non-patent document 1).

The performance exercised by the glass transition temperature (Tg) of a polymer compound constituting a resist has hitherto been scarcely discussed. In recent years, it has been proved that in the patterning of a resist comprising a polymer having a low glass transition temperature (Tg), the disadvantages of deformation of a pattern formed and decreased pattern size lower than that of a mask pattern occur because of a high rate of diffusion of an acid generated from a photoacid generator. Further, the bake temperature at the time of pattering should be set to a temperature lower than the glass transition temperature (Tg), and a lot of trouble has been taken to change and readjust pattering process conditions such as the bake temperature in the case of a resist having a glass transition temperature (Tg) lower than the ordinary bake temperature (120 to 130° C.). In spite of the occurrence of these problems, a molecular design giving attention to raising the glass transition temperature (Tg) has hitherto been scarcely made, and further, there has been no molecule at all which has a high glass transition temperature (Tg), and high transparency, high etching resistance, high adhesion to substrate and film forming properties at once. It has been therefore strongly desired to create a novel monomer satisfying all these functions or a polymer compound thereof.

Patent Document 1: JP 9-73173 A

Patent Document 2: JP 10-10739 A

Patent Document 3: JP 9-230595 A

Patent Document 4: WO 97/33198

Non-Patent Document 1: Proc. SPIE. 4345, pp. 273-284, 2001 (SPIE 2001, Lecture NO. 4345-31, Polymer design for 157-nm chemically amplified resists)

Non-Patent Document 2: Proc. SPIE. 4690, pp. 76-83, 2002 (SPIE 2002, Lecture NO. 4690-09, Synthesis of fluoropolymers for 157 nm photoresists by cyclo-polymerization)

### SUMMARY OF THE INVENTION

It is an object of the present invention to provide a fluorine-containing acrylate compound which is a novel fluorine-containing polymerizable monomer.

Another object of the invention is to provide a polymer compound using the above-mentioned fluorine-containing acrylate.

A further object of the invention is to provide a resist compound using the above-mentioned polymer compound.

A still further object of the invention is to provide a patterning process using the above-mentioned resist composition.

Other objects and effects of the present invention will become apparent from the following description.

In order to achieve the above-mentioned objects, the present inventors have conducted intensive studies. As a result, there has been discovered a novel cyclic fluorine-containing polymerizable monomer having a hexafluoroisopropanol structure in the vicinity of a polymerizable group. A fluorine-based polymer compound obtained by polymerization or copolymerization using this fluorine-containing polymerizable monomer or a derivative thereof has a high fluorine content, high transparency in a wide wavelength region ranging from the ultraviolet region to the near infrared region, and high adhesion to substrate due to a hydroxyl group and film forming properties at once. Further, it has high etching resistance by containing a cyclic structure, and a high glass transition temperature by incorporating the bulky hexafluoroisopropanol structure in the vicinity of the polymerizable group to inhibit the movement of main polymer chains a resist composition and a patterning process using the same have been discovered. Thus, the invention has been completed.

That is, the above-mentioned objects of the invention have been attained by the following fluorine-containing polymerizable monomers 1 to 5, fluorine-containing polymer compounds 6 to 8, resist composition 9 using the same and patterning processes 10 and 11.

1. A fluorine-containing acrylate compound represented by general formula (1): 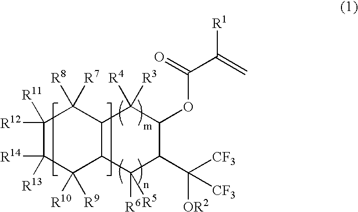
wherein R¹ is any one functional group of a hydrogen atom, a methyl group and a trifluoromethyl group; R² is a hydrogen atom or a straight-chain, branched or cyclic alkyl group having 1 to 25 carbon atoms, which may contain a fluorine atom, an oxygen atom, a nitrogen atom, a sulfur atom or a carbonyl bond at a part thereof; R³ to R¹⁴ are each a hydrogen atom or a straight-chain, branched or cyclic alkyl group having 1 to 25 carbon atoms, which may contain a fluorine atom, an oxygen atom, a nitrogen atom, a sulfur atom or a hydroxyl group at a part thereof; R³ and R⁵, R⁷ and R⁹, or two groups of R¹¹ to R¹⁴ may be combined with each other to form a ring as an alkylene group having 1 to 25 carbon atoms, which may contain an oxygen atom, a sulfur atom or a nitrogen atom at a part thereof; 1 is 0 or 1; and m and n each represents any integer of 0 to 4.

2. A fluorine-containing acrylate compound represented by general formula (2): 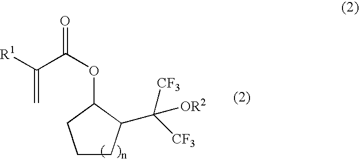
wherein R¹ is any one functional group of a hydrogen atom, a methyl group and a trifluoromethyl group; R² is a hydrogen atom or a straight-chain, branched or cyclic alkyl group having 1 to 25 carbon atoms, which may contain a fluorine atom, an oxygen atom, a nitrogen atom, a sulfur atom or a carbonyl bond at a part thereof; and n represents any integer of 0 to 8.

3. A fluorine-containing acrylate compound represented by general formula (3): 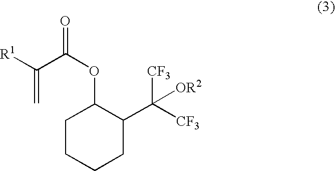
wherein R¹ is any one functional group of a hydrogen atom, a methyl group and a trifluoromethyl group; R² is a hydrogen atom or a functional group containing a straight-chain, branched or cyclic hydrocarbon group having 1 to 25 carbon atoms, which may contain a fluorine atom, an oxygen atom, a nitrogen atom, a sulfur atom or a carbonyl bond at a part thereof.

4. The fluorine-containing acrylate compound described in any one of the above 1 to 3, wherein R² of any one of general formulas (1) to (3) contains an acid-labile group (the acid-labile group is an acid-leaving group, which may contain a fluorine atom, an oxygen atom or a carbonyl bond at a part thereof).

5. A fluorine-containing acrylate compound represented by general formula (4): 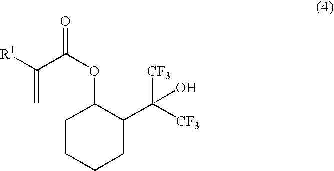
wherein R¹ is any one functional group of a hydrogen atom, a methyl group and a trifluoromethyl group.

6. A fluorine-containing polymer compound which is a polymer or a copolymer of the fluorine-containing acrylate compound described in any one of the above 1 to 5.

7. The fluorine-containing polymer compound described in the above 6, which is a copolymer of a compound having an acid-labile group and the above-mentioned fluorine-containing acrylate compound.

8. The fluorine-containing polymer compound described in the above 6, which is a copolymer of a compound having a lactone structure and the above-mentioned fluorine-containing acrylate compound.

9. A resist composition containing the polymer compound described in any one of the above 6 to 8.

10. A patterning process comprising the steps of:

applying the resist composition described in the above 9 onto a substrate,

conducting exposure to a high energy ray having a wavelength ranging from 1 to 300 nm through a photomask, and

performing developing treatment with a developing solution after heat treatment.

11. The patterning process described in the above 10, wherein the high energy ray is a KrF laser beam, an ArF laser beam, an F₂ laser beam, an EUV laser beam or an X-ray.

The fluorine-based polymer compound and resist composition of the invention respond to high energy rays, and excellent in sensitivity at a wavelength of 300 nm or less, particularly 200 nm or less. Moreover, it has been proved that the transparency, adhesion, film forming properties, etching resistance and glass transition temperature (Tg) of the resist composition are improved by using the polymer compound as a base resin for the resist composition, the polymer compound being obtained by polymerization or copolymerization of the fluorine-containing acrylate compound represented by any one of general formulas (1) to (4) in which a bulky hexafluoroisopropanol structure is incorporated in the vicinity of a polymerizable group. According to these characteristics, the resist composition of the invention is possible to become a resist composition particularly low in absorption at exposure wavelengths of excimer laser beams and X-rays. There is therefore provided the resist composition having high transparency in a wide wavelength region ranging from the ultraviolet region to the near infrared region, and high adhesion to substrate due to a hydroxyl group, film forming properties, high etching resistance and high glass transition temperature (Tg) at once. Furthermore, according to the pattering method of the invention, a pattern which is minute and perpendicular to the substrate can be easily formed, and the resist composition of the invention becomes suitable as a micropatterning material for very large scale integration production.

### DETAILED DESCRIPTION OF THE INVENTION

The present invention will be described in detail below. It has been found that transmittance, resin adhesion to substrate, film forming properties and permeability of a developing solution can be improved at once by reducing the number of carbonyl groups and carbon-carbon double bonds from the structure of a monomer or a polymer compound, and by incorporating a hexafluoroisopropanol structure therein. Actually, it has been confirmed that the use of an acrylic resin in which the hexafluoroisopropanol structure is incorporated improves the above-mentioned performances to a level close to a practical one, and that the introduction of an aliphatic cyclic structure improves etching resistance. However, the polymer compound has a low glass transition temperature (Tg), so that an acid generated from a photoacid generator has a high rate of diffusion in patterning of a resist comprising the polymer compound. It has therefore found that the disadvantages of deformation of a pattern formed and decreased pattern size lower than that of a mask pattern occur. At the same time, the resist composition has a low glass transition temperature (Tg), so that a lot of trouble has been taken for rationalization by changing and readjusting pattering process conditions such as the bake temperature.

In contrast, the fluorine-containing acrylate compound represented by any one of general formulas (1) to (4) has a bulky hexafluoroisopropanol structure in the vicinity of a polymerizable group. Accordingly, the polymer compound containing it can inhibit the movement of main polymer chains, and has dramatically raised the glass transition temperature (Tg) compared to before. As a result, it has become clear that ordinary patterning process conditions can be applied, thereby also inhibiting the rate of acid diffusion to obtain rectangular patterning without changing the ordinary conditions. Further, since it has also a cyclic structure, etching resistance has also been on a satisfactory level.

Accordingly, the invention provides the fluorine-containing acrylate compound and the polymer compound thereof. It has been discovered that the glass transition temperature (Tg) is dramatically improved in the polymer compound to obtain rectangular patterning, while having high transparency, substrate adhesion, film forming properties, permeability of a developing solution and high etching resistance.

In the compound represented by any one of general formulas (1) to (4), R¹ is a hydrogen atom, a methyl group or a trifluoromethyl group. However, when it is used as a material requiring lower refractive index and high transparency, particularly transparency in an ultraviolet wavelength region, a trifluoromethyl group is preferably used.

In the compound represented by any one of general formulas (1) to (3) of the invention, R is a hydrogen atom or a straight-chain, branched or cyclic alkyl group having 1 to 25 carbon atoms, and a functional group which may contain a fluorine atom, an oxygen atom, a nitrogen atom, a sulfur atom or a carbonyl bond at a part thereof. Examples of the straight-chain, branched or cyclic alkyl groups having 1 to 25 carbon atoms which can be used as R² include a methyl group, a ethyl group, a propyl group, an isopropyl group, a cyclopropyl group, an n-propyl group, a sec-butyl group, a tert-butyl group, cyclobutyl group, an n-pentyl group, a cyclopentyl group, a sec-pentyl group, a neopentyl group, a hexyl group, a cyclohexyl group, an ethylhexyl group, a pentenyl group, an octyl group, a nonanyl group, a decanyl group, a norbornel group, an adamantyl group, a vinyl group, an allyl group, a butenyl group, a pentenyl group, an ethynyl group and the like. The alkyl group containing an oxygen atom, a nitrogen atom, a sulfur atom or a carbonyl bond is a functional group that has such an atom or group in the form of —OH, —OR¹⁵, —O—, —C (═O)—, —S—, —S (═O)—, —S (═O)₂—, —NH₂—, —NHR¹⁵—, —N(R¹⁵)₂— or the like contained or intervening in the above-mentioned alkyl group. R¹⁵ represents a straight-chain, branched or cyclic alkyl group having 1 to 25 carbon atoms. A functional group in which the above-mentioned alkyl group or heteroatom-containing alkyl group is partially or fully substituted by fluorine can also be used.

In the compound represented by general formula (1) of the invention, R³ to R¹⁴ are each a hydrogen atom or a straight-chain, branched or cyclic alkyl group having 1 to 25 carbon atoms, and a functional group which may contain an oxygen atom, a nitrogen atom, a sulfur atom or a hydroxyl group at a part thereof. Examples of the straight-chain, branched or cyclic alkyl groups having 1 to 25 carbon atoms which can be used as R³ to R¹⁴ include a methyl group, a ethyl group, a propyl group, an isopropyl group, a cyclopropyl group, an n-propyl group, a sec-butyl group, a tert-butyl group, cyclobutyl group, an n-pentyl group, a cyclopentyl group, a sec-pentyl group, a neopentyl group, a hexyl group, a cyclohexyl group, an ethylhexyl group, a pentenyl group, an octyl group, a nonanyl group, a decanyl group, a norbornel group, an adamantyl group, a vinyl group, an allyl group, a butenyl group, a pentenyl group, an ethynyl group and the like. The alkyl group containing a fluorine atom, an oxygen atom, a nitrogen atom, a sulfur atom or a hydroxyl group is a functional group that has such an atom in the form of —OH, —OR⁵, —O—, —S—, —S(═O)—, —S(═O)₂—, —NH₂—, —NHR¹⁵—, —N(R¹⁵)₂— or the like contained or intervening in the above-mentioned alkyl group. R¹⁵ represents a straight-chain, branched or cyclic alkyl group having 1 to 25 carbon atoms. A functional group in which the above-mentioned alkyl group or heteroatom-containing alkyl group is partially or fully substituted by fluorine can also be used. Further, an alkylene group having 1 to 25 carbon atoms can also be used in which R³ and R⁵, R⁷ and R⁹, or two groups of R¹¹ to R¹⁴ is combined with each other to form a ring. The alkylene group includes groups formed by eliminating one hydrogen atom in the above-mentioned alkylene groups. The alkylene group containing an oxygen atom, a sulfur atom or a nitrogen atom is a functional group that has such an atom in the form of —O—, —S—, —S(═O)—, —S(═O)₂—, —NH₂—, —NHR¹⁵—, —N(R¹⁵)₂— or the like contained or intervening in the alkylene group. A functional group in which the above-mentioned alkylene group or heteroatom-containing alkylene group is partially or fully substituted by fluorine can also be used.

In the compound represented by general formula (1) of the invention, l is 0 or 1, and m and n are each an integer of 0 to 4. In the compound represented by general formula (2), n represents any integer of 0 to 8.

Then, the acid-labile group which can be used as R² in general formulas (1) to (3) will be described below. The acid-labile group of R² is a so-called acid-leaving group, which may contain an oxygen atom, a carbonyl bond or a fluorine atom at a part thereof.

The purpose for using the acid-labile group is to exhibit positive type photosensitivity and solubility in an alkali solution after exposure to a high energy ray such as a far infrared ray having a wavelength of 300 nm or less, an excimer laser beam or an X-ray, or an electron beam, by the acid-labile group. One having a fluorine atom in its functional group is used for imparting transparency, and one containing a cyclic structure is used for further imparting characteristics such as etching resistance and high transition temperature (Tg). It is possible to appropriately select them for each field of application of the invention.

In the invention, the acid-labile group can be used without any particular limitation, as long as it is a group eliminable by the effect of a photoacid generator, hydrolysis or the like. Specific examples thereof include an alkoxycarbonyl group, an acetal group, a silyl group, an acyl group and the like. The alkoxycarbonyl group include a tert-butoxycarbonyl group, a tert-amyloxycarbonyl group, a methoxycarbonyl group, an ethoxycarbonyl group, an i-propoxycarbonyl group and the like. Examples of the acetal groups include a methoxymethyl group, an ethoxyethyl group, a butoxyethyl group, a cyclohexyloxyethyl group, a benzyloxyethyl group, a phenethyloxyethyl group, an ethoxypropyl group, a benzyloxypropyl group, a phenethyloxypropyl group, an ethoxybutyl group, an ethoxyisobutyl group and the like. Further, when R² and R³ are each a hydrogen atom, an acetal group can also be used in which a vinyl ether has been added to the hydroxyl group. The silyl groups include, for example, a trimethylsilyl group, an ethyldimethylsilyl group, a methyldiethylsilyl group, a triethylsilyl group, an i-propyldimethylsilyl group, a methyldi-i-propylsilyl group, a tri-i-propylsilyl group, a t-butyldimethylsilyl group, a methyldi-t-butylsilyl group, a tri-t-butylsilyl group, a phenyldimethylsilyl group, a methyldiphenylsilyl group, a triphenylsilyl group and the like. The acyl groups include an acetyl group, a propionyl group, a butyryl group, a heptanoyl group, a hexanoyl group, a valeryl group, a pivaloyl group, an isovaleryl group, a lauryloyl group, a myristoyl group, a palmiotyl group, a stearoyl group, an oxalyl group, a malonyl group, a succinyl group, a glutaryl group, an adipoyl group, a piperoyl group, a suberoyl group, an azelaoyl group, a sebacoyl group, an acryloyl group, a propioloyl group, a methacryloyl group, a crotonoyl group, an oleoyl group, a maleoyl group, a fumaroyl group, a mesaconoyl group, a campholoyl group, a benzoyl group, a phthaloyl group, an isophthaloyl group, a terephthaloyl group, a naphthoyl group, a toluoyl group, a hydroatropoyl group, an atropoyl group, a cinnamoyl group, a furoyl group, a thenoyl group, a nicotinoyl group, an isonicotinoyl group and the like. Further, as these acid-labile groups, there can also be used ones in which hydrogen atoms have been partially or fully substituted by fluorine atoms.

Further, according to the invention, the compound represented by general formula (4) is suitably employed as a base compound for the fluorine-containing acrylate compound of the invention. According to the invention, the compound represented by general formula (4) (wherein R¹ represents any one functional group of a hydrogen atom, a methyl group and a trifluoromethyl group) is a most fundamental fluorine-containing acrylate compound for deriving various fluorine-containing acrylate compounds represented by general formulas (1) to (3).

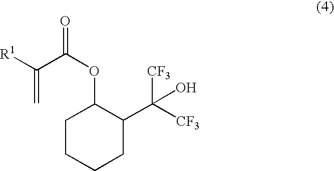

Methods for synthesizing the compounds represented by general formulas (1) to (4) will be described below.

The compounds represented by general formulas (1) to (4) are derived from the corresponding alcohols. Referring to general formula (4), a fluorine-containing alcohol derivative represented by structural formula (5) is reacted with an acrylic acid derivative in the presence of an acid or a base, thereby synthesizing the fluorine-containing acrylate compound represented by general formula (4).

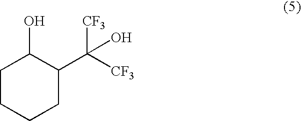

The acrylic acid derivative includes acrylic acid, methacrylic acid, trifluoroacrylic acid, acrylic anhydride, methacrylic anhydride, trifluoroacrylic anhydride, acrylic acid chloride, methacrylic acid chloride, trifluoroacrylic acid chloride and the like. The carboxylic acid can be used in the presence of an acid, and the anhydride and acid chloride can be used in the presence of an acid and a base. The use of the anhydride provides an appropriate reaction rate, so that it is suitably employed. The amount of the acrylic acid derivative used is sufficient if it is equal to or more than the molar quantity of the fluorine-containing alcohol derivative (structural formula (5)) used as a starting material. From the viewpoints of the reaction rate and the yield of the desired fluorine-containing acrylate compound (general formula (4)), the amount is preferably from 1.1 to 2 times the molar quantity of the alcohol derivative.

The acids which can be used include protonic acids and Lewis acids. Examples thereof include protonic acids such as hydrogen fluoride, sulfuric acid, phosphoric acid, hydrogen chloride, methanesulfonic acid, trifluoromethanesulfonic acid and trifluoroacetic acid, and Lewis acids such as aluminum chloride, aluminum bromide, gallium chloride, gallium bromide, ferric chloride (FeCl₃), zinc chloride, antimony chloride, titanium tetrachloride, tin tetrachloride, boron trifluoride, Ti(OCH₃)₄, Ti(OC₂H₅)₄, Ti(OC₄H₉)₄, Ti(OCH(CH₃)₂)₄ and Zn(CH₃COO)₂.2H₂O. Of these, the protonic acids are preferably employed, because desired products are obtained in satisfactory yields on their use. More preferably, methanesulfonic acid is employed whose reaction rapidly proceeds and which is easily available.

The amount of the acid which can be used is from 0.01 to 10 times the molar quantity of the fluorine-containing alcohol derivative (structural formula (5) used as a starting material. However, amounts less than 0.01 mol are not realistic, because the reaction rate is too slow, and the yield of the desired fluorine-containing acrylate compound (general formula (4)) is very low. On the other hand, even when the acid is added in an amount of 10 times or more the molar quantity of the alcohol derivative, the effect of improving the yield cannot be expected, and by-products also increase. More preferably, the acid is used in an amount of 0.1 to 1.5 times the molar quantity of the alcohol derivative based on a substrate, thereby achieving an appropriate reaction rate and a satisfactory yield.

The reason for using the base in this reaction is that when the anhydride or the acid chloride is used as the acrylic acid derivative, the base is used for capturing an acid (a carboxylic acid or hydrogen chloride) generated by the reaction. Organic bases such as pyridine, lutidine, triethylamine, diethylamine, piperidine, pyrrolidine and 1,8-diazacyclo[5,4,0]-7-undecene, as well as inorganic bases such as sodium hydroxide, sodium carbonate, sodium hydrogen carbonate, potassium hydroxide, potassium carbonate, potassium hydrogen carbonate, sodium hydride, sodium methoxide, sodium ethoxide, sodium tert-butoxide and potassium tert-butoxide can be used. The organic base is preferably used, and lutidine is particularly preferably used. The base is used in an amount of 1 to 10 mol, preferably 1 to 3 mol, per mol of the compound of structural formula (5).

There is no particular limitation on a solvent, as long as it does not participate in the reaction and dissolves the fluorine-containing alcohol derivative (structural formula (5)) used as a starting material. Examples thereof include hydrocarbons such as hexane, heptane, benzene, toluene and xylene, ethers such as diethyl ether, tetrahydrofuran and dioxane, halogenated hydrocarbons such as dichloromethane and chloroform, and aprotic polar solvents such as acetonitrile, N,N-dimethylformamide, dimethyl sulfoxide and hexamethyl-phosphoric triamide. These may be used either singly or as a mixture of two or more thereof.

Although the reaction temperature is not particularly limited, the reaction is usually possible at a temperature within the range of room temperature to 200° C. The reaction rate varies depending on the kinds and amounts of the above-mentioned acrylic acid derivatives, acids and bases, the reaction temperature and the like, so that the reaction time is appropriately changed in conformity therewith. Actually, it is possible to conduct the reaction while sequentially synthesizing the reaction solution during the reaction until the starting materials are consumed. Although treatment after the reaction is not particularly limited, a process of taking out a desired product by an extraction operation with an organic solvent after the reaction solution has been poured into water or ice water, or a process of taking out a desired product by flush evaporation is available.

The polymer compound according to the invention will be described below. The term “polymer compound” as used in the invention means a polymer material obtained by homopolymerizing or copolymerizing any one of the fluorine-containing acrylate compounds represented by general formulas (1) to (4).

Specific examples of monomers copolymerizable with the fluorine-containing polymerizable acrylate compound of the invention include an acrylic ester, a methacrylic ester, a fluorine-containing acrylic ester, a fluorine-containing methacrylic ester, a styrene compound, a fluorine-containing styrene compound, a vinyl ether, a fluorine-containing vinyl ether, an allyl ether, a fluorine-containing allyl ether, an olefin, a fluorine-containing olefin, a norbornene compound and a fluorine-containing norbornene compound. It is suitable that the fluorine-containing polymerizable acrylate compound is copolymerized with one or more monomers selected therefrom.

The acrylic ester or methacrylic ester can be used in the invention without any particular limitation on an ester side chain. Examples of known compounds include alkyl esters of acrylic acid or methacrylic acid such as methyl acrylate or methacrylate, ethyl acrylate or methacrylate, n-propyl acrylate or methacrylate, isopropyl acrylate or methacrylate, n-butyl acrylate or methacrylate, isobutyl acrylate or methacrylate, n-hexyl acrylate or methacrylate, n-octyl acrylate or methacrylate, 2-ethylhexyl acrylate or methacrylate, lauryl acrylate or methacrylate, 2-hydroxyethyl acrylate or methacrylate and 2-hydroxypropyl acrylate or methacrylate; acrylates or methacrylates containing an ethylene glycol, propylene glycol or tetramethylene glycol group; unsaturated amides such as acrylamide, methacrylamide, N-methylolacrylamide, N-methylolmethacrylamide and diacetoneacrylamide; acrylonitrile, methacrylonitrile, alkoxysilane-containing vinylsilanes, alkoxysilane-containing acrylates or methacrylates, tert-butyl acrylate or methacrylate, 3-oxo-cyclohexyl acrylate or methacrylate, adamantly acrylate or methacrylate, alkyladamantyl acrylates or methacrylates, cyclohexyl acrylate or methacrylate, tricyclodecanyl acrylate or methacrylate, acrylates or methacrylates having a ring structure such as a lactone ring or a norbornene ring, acrylic acid and methacrylic acid. Further, the above-mentioned acrylate compound which has a cyano group at the α-position and a copolymer with maleic acid, fumaric acid or maleic anhydride can also be used as an analogous compound.

Further, as the fluorine-containing acrylate or fluorine-containing methacrylate which can be used in the invention, a monomer having a fluorine atom or a fluorine-containing group at the α-position of the acrylic acid moiety, and an acrylate or methacrylate comprising a substituent group containing a fluorine atom at its ester moiety, which is a fluorine-containing compound containing fluorine atoms both at the α-position and the ester moiety, are also suitable. In addition, a cyano group may be introduced into the α-position. For example, as the monomer with a fluorine-containing alkyl group introduced into the α-position, suitably employed is a monomer in which a trifluoromethyl group, a trifluoroethyl group, a nonafluoro-n-butyl group or the like is imparted to the α-position of the above-mentioned non-fluorine acrylate or methacrylate. In that case, fluorine is not necessarily contained in the ester moiety. When an alkyl α-trifluoro-methylacrylate is used as a copolymerization component, the yield of a polymer is relatively high, and solubility of the resulting polymer in an organic solvent is good. This is therefore preferably employed.

On the other hand, the monomer containing fluorine at the ester moiety is an acrylate or methacrylate having, as its ester moiety, a fluorine alkyl group such as a perfluoroalkyl group or a fluoroalkyl group, or having a unit in which a cyclic structure and a fluorine atom coexist at the ester moiety wherein the cyclic structure comprises a fluorine-containing benzene ring, a fluorine-containing cyclopentane ring, a fluorine-containing cyclohexane ring or a fluorine-containing cycloheptane ring which has been substituted, for example, by a fluorine atom, a trifluoromethyl group or a hexafluorocarbinol group. Further, an acrylate or methacrylate in which its ester moiety is a fluorine-containing t-butyl ester group may also be used. Monomers having such a fluorine-containing functional group in combination with a fluorine-containing alkyl group at the α-position may also be used. Particularly typical examples of such units shown in the form of monomers include 2,2,2-trifluoroethyl acrylate, 2,2,3,3-tetrafluoropropyl acrylate, 1,1,1,3,3,3-hexafluoroisopropyl acrylate, heptafluoroisopropyl acrylate, 1,1-dihydroheptafluoro-n-butyl acrylate, 1,1,5-trihydrooctafluoro-n-pentyl acrylate, 1,1,2,2-tetrahydrotridecafluoro-n-octyl acrylate, 1,1,2,2-tetrahydroheptadecafluoro-n-decyl acrylate, 2,2,2-trifluoroethyl methacrylate, 2,2,3,3-tetrafluoropropyl methacrylate, 1,1,1,3,3,3-hexafluoroisopropyl methacrylate, heptafluoroisopropyl methacrylate, 1,1-dihydroheptafluoro-n-butyl methacrylate, 1,1,5-trihydrooctafluoro-n-pentyl methacrylate, 1,1,2,2-tetrahydrotridecafluoro-n-octyl methacrylate, 1,1,2,2-tetrahydroheptadecafluoro-n-decyl methacrylate, perfluorocyclohexylmethyl acrylate, perfluorocyclohexylmethyl methacrylate, 6-[3,3,3-trifluoro-2-hydroxy-2-(trifluoromethyl)propyl]bicyclo[2.2.1]heptyl-2-yl acrylate, 6-[3,3,3-trifluoro-2-hydroxy-2-(trifluoromethyl)propyl]bicyclo[2.2.1]heptyl-2-yl-2-(trifluoromethyl)acrylate, 6-[3,3,3-trifluoro-2-hydroxy-2-(trifluoromethyl)propyl]bicyclo[2.2.1]heptyl-2-yl methacrylate, 1,4-bis(1,1,1,3,3,3-hexafluoro-2-hydroxy-isopropyl)cyclohexyl acrylate, 1,4-bis(1,1,1,3,3,3-hexafluoro-2-hydroxyisopropyl)cyclohexyl methacrylate, 1,4-bis(1,1,1,3,3,3-hexafluoro-2-hydroxyisopropyl)cyclohexyl-2-trifluoromethyl acrylate and the like.

Further, the styrene compounds and fluorine-containing styrene compounds which can be used in the invention include, as well as styrene, fluorinated styrene and hydroxystyrene, a compound to which one or a plurality of hexafluorocarbinol groups or functional groups modified at the hydroxyl groups thereof are connected. That is, styrene or hydrostyrene in which fluorine or trifluoromethyl is substituted for hydrogen, the above-mentioned styrene in which halogen, alkyl or fluorine-containing alkyl is bonded to the α-position, perfluorovinyl group-containing styrene or the like can be preferably used.

Further, as the vinyl ether, the fluorine-containing vinyl ether, the allyl ether and the fluorine-containing allyl ether, there can also be used an alkyl vinyl ether or alkyl allyl ether which may contain a methyl group, an ethyl group, a propyl group, a butyl group or a hydroxyl group such as a hydroxyethyl group or a hydroxybutyl group, a cyclic vinyl ether or allyl ether having a cyclohexyl group or a hydrogen or carbonyl bond in its cyclic structure, and a fluorine-containing vinyl ether or allyl ether in which fluorine is partially or fully substituted for hydrogen of the above-mentioned functional group. It is also possible to use a vinyl ester, a vinyl silane, an olefin, a fluorine-containing olefin, a norbornene compound, a fluorine-containing norbornene compound and other compounds containing polymerizable unsaturated bonds, without any particular limitation.

The olefin includes ethylene, propylene, isobutene, cyclopentene, cyclohexane and the like. The fluorine-containing olefin includes vinyl fluoride, vinylidene fluoride, trifluoroethylene, chlorotrifluoroethylene, tetrafluoroethylene, hexafluoropropylene, hexafluoroisobutene and the like.

The norbornene compound and fluorine-containing norbornene compound are a norbornene monomer having a mononucleus or multinucleus structure. In this case, the norbornene monomer is a norbornene compound formed by the Diels-Alder addition reaction of an unsaturated compound such as a fluorine-containing olefin, allyl alcohol, fluorine-containing allyl alcohol, homoallyl alcohol, fluorine-containing homoalcohol, acrylic acid, α-fluoroacrylic acid, α-trifluoromethylacrylic acid, methacrylic acid, all of the above-mentioned acrylates, methacrylates, fluorine-containing acrylates or fluorine-containing methacrylates, 2-(benzoyloxy)pentafluoropropane, 2-(methoxyethoxymethyloxy)pentafluoropropene, 2-(tetrahydroxypyranyloxy)pentafluoropropene, 2-(benzoyloxy)trifluoroethylene or 2-(methoxymethyloxy)trifluoroethylene) to cyclopentadiene or cyclohexadiene, and there can be exemplified 3-(5-bicyclo-[2.2.1]heptene-2-yl)-1,1,1-trifluoro-2-(trifluoromethyl)-2-propanol or the like. The above-mentioned copolymer compounds may be used either singly or as a combination of two or more thereof.

The copolymerization composition ratio of the fluorine-containing acrylate compound can be employed without any particular limitation. However, it is selected preferably between 10% and 100%, and more preferably between 30% and 100%. The amount of the former is preferably 10-100%, more preferably 30-100%. When it is less than 30%, sufficient transparency or film-forming properties are not developed in some cases depending on the wavelength range in the field of application.

The polymerization method of the polymer composition according to the invention is not particularly limited, as long as it is a method which is generally used. However, radical polymerization and ionic polymerization are preferred. In some cases, it is also possible to use coordinated anionic polymerization, living anionic polymerization and the like. The radical polymerization method which is more general will be described herein. That is, the radical polymerization may be conducted by a known polymerization method such as bulk polymerization, solution polymerization, suspension polymerization or emulsion polymerization by a batch-wise, half-continuous or continuous operation in the presence of a radical polymerization initiator or a radical initiating source.

Examples of the radical polymerization initiators include but are not particularly limited to an azo compound, a peroxide compound and a redox compound. Particularly preferred are azobisbutyronitrile, t-butyl peroxypivalate, di-t-butyl peroxide, i-butyryl peroxide, lauroyl peroxide, succinic acid peroxide, dicinnamyl peroxide, di-n-propyl peroxydicarbonate, t-butylperoxyallyl monocarbonate, benzoyl peroxide, hydrogen peroxide, ammonium persulfate and the like.

A reaction vessel used for the polymerization reaction is not particularly limited. Further, a polymerization solvent may be used in the polymerization reaction. The polymerization solvent is preferably one which does not inhibit the radical polymerization. Typical examples thereof include esters such as ethyl acetate and n-butyl acetate; ketones such as acetone and methyl isobutyl ketone; hydrocarbons such as toluene and cyclohexane; and alcohol solvents such as methanol, isopropyl alcohol and ethylene glycol monomethyl ether. Furthermore, it is also possible to use various solvents such as water, ether, cyclic ether, fluorohydrocarbon and aromatic solvents. These solvents can be used either singly or as a mixture of two or more thereof. In addition, a molecular weight adjusting agent such as mercaptan may be used together. The reaction temperature of the copolymerization reaction is appropriately changed depending on the radical polymerization initiator or radical polymerization initiating source. It is usually preferably from 20 to 200° C., and particularly preferably from 30 to 140° C.

As a method for removing the organic solvent or water, or a medium, from the solution or dispersion of the thus-obtained polymer compound according to the invention, any known method can be employed. Examples thereof include methods such as reprecipitation followed by filtration and distillation by heating under vacuum. The number average molecular weight of the resulting polymer compound of the invention is usually from 1,000 to 100,000, and preferably from 3,000 to 50,000.

The copolymer with an acid-labile group-containing compound will be described below. The purpose for using the acid-labile group is to exhibit positive type photosensitivity and solubility in an alkali solution after exposure to a high energy ray such as a far infrared ray having a wavelength of 300 nm or less, an excimer laser beam or an X-ray, or an electron beam. One having a fluorine atom in its functional group is used for imparting transparency, and one containing a cyclic structure is used for further imparting characteristics such as etching resistance and high transition temperature (Tg). It is possible to appropriately select them for each field of application of the invention.

The acid-labile group-containing compound is a compound having the acid-labile group and polymerizable group described below together, and the acid-labile group is a group eliminable by the effect of a photoacid generator, hydrolysis or the like. Examples thereof include an alkoxycarbonyl group, an acetal group, a silyl group, an acyl group and the like. The alkoxycarbonyl group includes a tert-butoxycarbonyl group, a tert-amyloxycarbonyl group, a methoxycarbonyl group, an ethoxycarbonyl group, an i-propoxycarbonyl group and the like. Examples of the acetal groups include a methoxymethyl group, an ethoxyethyl group, a butoxyethyl group, a cyclohexyloxyethyl group, a benzyloxyethyl group, a phenethyloxyethyl group, an ethoxypropyl group, a benzyloxypropyl group, a phenethyloxypropyl group, an ethoxybutyl group, an ethoxyisobutyl group and the like. Further, when R² and R³ are each a hydrogen atom, an acetal group in which a vinyl ether has been added to its hydroxyl group can also be used. The silyl groups include, for example, a trimethylsilyl group, an ethyldimethylsilyl group, a methyldiethylsilyl group, a triethylsilyl group, an i-propyldimethylsilyl group, a methyldi-i-propylsilyl group, a tri-i-propylsilyl group, a t-butyldimethylsilyl group, a methyldi-t-butylsilyl group, a tri-t-butylsilyl group, a phenyldimethylsilyl group, a methyldiphenylsilyl group, a triphenylsilyl group and the like. The acyl groups include an acetyl group, a propionyl group, a butyryl group, a heptanoyl group, a hexanoyl group, a valeryl group, a pivaloyl group, an isovaleryl group, a lauryloyl group, a myristoyl group, a palmiotyl group, a stearoyl group, an oxalyl group, a malonyl group, a succinyl group, a glutaryl group, an adipoyl group, a piperoyl group, a suberoyl group, an azelaoyl group, a sebacoyl group, an acryloyl group, a propioloyl group, a methacryloyl group, a crotonoyl group, an oleoyl group, a maleoyl group, a fumaroyl group, a mesaconoyl group, a campholoyl group, a benzoyl group, a phthaloyl group, an isophthaloyl group, a terephthaloyl group, a naphthoyl group, a toluoyl group, a hydroatropoyl group, an atropoyl group, a cinnamoyl group, a furoyl group, a thenoyl group, a nicotinoyl group, an isonicotinoyl group and the like. Further, as these acid-labile groups, those in which hydrogen atoms have been partially or fully substituted by fluorine atoms can also be used.

The polymerizable group includes an acrylic ester, a methacrylic ester, a fluorine-containing acrylic ester, a fluorine-containing methacrylic ester, a styrene compound, a fluorine-containing styrene compound, a vinyl ether, a fluorine-containing vinyl ether, an allyl ether, a fluorine-containing allyl ether, an olefin, a fluorine-containing olefin, a norbornene compound, a fluorine-containing norbornene compound and the like. The copolymer with the acid-labile group-containing compound means a polymer material obtained by copolymerizing the compound having both the above-mentioned acid-labile group and polymerizable group with the fluorine-containing acrylate compound represented by any one of general formulas (1) to (4).

The copolymer with a lactone structure-containing compound will be described below. The purpose for containing the lactone structure is to improve substrate adhesion and film forming properties of the resin, and to inhibit developing solution repellency. One having a fluorine atom in its functional group is used for imparting transparency, and one containing a cyclic structure is used for further imparting characteristics such as etching resistance and high transition temperature (Tg). It is possible to appropriately select them for each field of application of the invention.

The lactone structure-containing compound is a compound having the lactone structure and the polymerizable group together. The lactone structures include the structures shown below, wherein R¹⁶ is —CH2——NH—, —S— or —O—, and R¹⁷ is a hydrogen atom or a straight-chain, branched or cyclic alkyl group having 1 to 25 carbon atoms. The polymerizable group include an acrylic ester, a methacrylic ester, a fluorine-containing acrylic ester, a fluorine-containing methacrylic ester, a styrene compound, a fluorine-containing styrene compound, a vinyl ether, a fluorine-containing vinyl ether, an allyl ether, a fluorine-containing allyl ether, an olefin, a fluorine-containing olefin, a norbornene compound, a fluorine-containing norbornene compound and the like.

The copolymer with the lactone structure-containing compound means a polymer material obtained by copolymerizing the compound as shown below having both the lactone structure and the polymerizable group with the fluorine-containing acrylate compound represented by any one of general formulas (1) to (4).

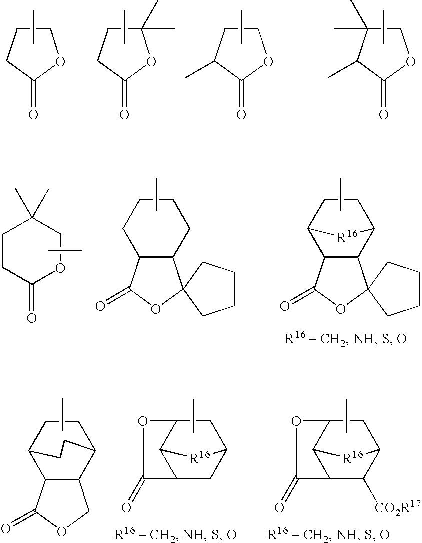

The polymer compound of the invention can be used as a base resin for a resist composition, particularly for a chemically amplified resist composition, more particularly for a chemically amplified positive type resist composition. However, in order to change mechanical properties, thermal properties, alkali solubility and other physical properties, another polymer compound can also be mixed therewith. In that case, the range of the polymer compound to be mixed is not particularly limited, and the polymer compound of the invention can be mixed with a known polymer compound for resist in any range.

The resist composition of the invention can be prepared by using known components, except that the polymer compound of the invention is used as the base resin. Particularly, the chemically amplified positive type resist composition comprises the above-mentioned polymer compound (base resin), organic solvent and acid generator. In this case, a basic compound or a dissolution inhibitor may be further blended with the resist composition.

The organic solvent usable in the invention may be any, as long as the base resin, the acid generator and other additives are soluble therein. Such organic solvents include, for example, ketones such as cyclohexanone and methyl-2-n-amylketone; alcohols such as 3-methoxybutanol, 3-methyl-3-methoxybutanol, 1-methoxy-2-propanol and 1-ethoxy-2-propanol; ethers such as propylene glycol monomethyl ether, ethylene glycol monomethyl ether, propylene glycol monoethyl ether, ethylene glycol monoethyl ether, propylene glycol dimethyl ether and diethylene glycol dimethyl ether; and esters such as propylene glycol monomethyl ether acetate, propylene glycol monoethyl ether acetate, ethyl lactate, ethyl pyruvate, butyl acetate, methyl 3-methoxypropionate, ethyl 3-ethoxypropionate, tert-butyl acetate, tert-butyl propionate and propylene glycol mono-tert-butyl ether acetate.

Further, a fluorinated organic solvent can also be used. Specific examples thereof include 2-fluoroanisole, 3-fluoroanisole, 4-fluoroanisole, 2,3-difluoroanisole, 2,4-difluoroanisole, 2,5-difluoroanisole, 5,8-difluoro-1,4-benzodioxane, 2,3-difluorobenzyl alcohol, 1,3-difluoro-2-propanol, 2′,4′-difluoropropiophenone, 2,4-difluorotoluene, trifluoroacetaldehyde ethylhemiacetal, trifluoroacetamide, trifluoroethanol, 2,2,2-trifluoroethyl butyrate, ethyl heptafluorobutyrate, ethyl heptafluorobutylacetate, ethyl hexafluoroglutarylmethyl, ethyl-3-hydroxy-4,4,4-trifluorobutyrate, ethyl-2-methyl-4,4,4-trifluoroacetoacetate, ethyl pentafluorobenzoate, ethyl pentafluoropropionate, ethyl pentafluoropropinylacetate, ethyl perfluorooctanoate, ethyl-4,4,4-trifluoroacetoacetate, ethyl-4,4,4-trifluorobutyrate, ethyl-4,4,4-trifluorocrotonate, ethyl trifluoro-sulfonate, ethyl-3-(trifluoromethyl)butyrate, ethyl tri-fluoropyruvate, sec-ethyl trifluoroacetate, fluorocyclo-hexane, 2,2,3,3,4,4,4-heptafluoro-1-butanol, 1,1,1,2,2,3,3-heptafluoro-7,7-dimethyl-4,6-octanedione, 1,1,1,3,5,5,5-heptafluoropentane-2,4-dione, 3,3,4,4,5,5,5-heptafluoro-2-pentanol, 3,3,4,4,5,5,5-heptafluoro-2-pentanone, isopropyl-4,4,4-trifluoroacetate, methyl perfluorodenanoate, methyl perfluoro(2-methyl-3-oxahexanoate), methyl perfluorononanoate, methylperfluoro-octanoate, methyl-2,3,3,3-tetrafluoroporpionate, methyl trifluoroacetate, 1,1,1,2,2,6,6,6-octafluoro-2,4-hexanedione, 2,2,3,3,4,4,5,5-octafluoro-1-pentanol, 1H,1H,2H,2H-perfluoro-1-decanol, perfluoro(2,5-dimethyl-3,6-dioxane-anionic) acid methyl ester, 2H-perfluoro-5-methyl-3,6-dioxanonane, 1H,1H,2H,3H,3H-perfluorononane-1,2-diol, 1H,1H,9H-perfluoro-1-nonanol, 1H,1H-perfluorooctanol, 1H,1H,2H,2H-perfluorooctanol, 2H-perfluoro-5,8,11,14-tetramethyl-3,6,9,12,15-pentaoxaoctadecane, perfluorotri-butylamine, perfluorotrihexylamine, perfluoro(2,5,8-trimethyl-3,6,9-trioxadodecanoic) acid methyl ester, perfluorotripentylamine, perfluorotripropylamine, 1H,1H,2H,3H,3H-perfluoroundecane-1,2-diol, trifluorobutanol, 1,1,1-trifluoro-5-methyl-2,4-hexanedione, 1,1,1-trifluoro-2-propanol, 3,3,3-trifluoro-1-propanol, 1,1,1-trifluoro-2-propyl acetate, perfluoro(butyltetrahydrofuran), perfluorodecalin, perfluoro(1,2-dimethylcyclohexane), perfluoro(1,3-di-methylcyclohexane), propylene glycol trifluoromethyl ether acetate, propylene glycol methyl ether trifluoromethyl acetate, butyl trifluoromethylacetate, methyl 3-tri-fluoromethoxypropionate, perfluorocyclohexanone, propylene glycol trifluoromethyl ether, butyl trifluoroacetate, 1,1,1-trifluoro-5,5-dimethyl-2,4-hexanedione and the like. These solvents can be used either singly or as a mixture of two or more thereof, but are not limited thereto.

In the invention, of these organic solvents, preferably used are propylene glycol monomethyl acetate which is a safety solvent, and a mixed solvent thereof, as well as diethylene glycol dimethyl ether and 1-ethoxy-2-propanol which are most excellent, of these organic solvents, in solubility of the acid generator contained in the resist components. The amount of the above-mentioned solvent used is preferably from 300 to 10,000 parts, and particularly preferably from 500 to 5,000 parts, per 100 parts (by weight, hereinafter the same) of the base resin.

The acid generators include an onium salt, a diazomethane derivative, a glyoxime derivative, a β-ketosulfonic acid derivative, a disulfone derivative, a nitrobenzylsulfonate derivative, a sulfonic ester derivative, an imidoylsulfonate derivative and the like. Specific examples thereof include onium salts such as diphenyliodonium trifluoromethanesulfonate, (p-tert-butoxyphenyl)phenyliodonium trifluoromethanesulfonate, diphenyliodonium p-toluenesulfonate, (p-tert-butoxyphenyl)phenyliodonium p-toluenesulfonate, triphenylsulfonium trifluoromethanesulfonate, (p-tert-butoxyphenyl)diphenylsulfonium trifluoromethanesulfonate, bis(p-tert-butoxyphenyl)phenylsulfonium trifluoromethanesulfonate, tris(p-tert-butoxyphenyl)sulfonium trifluoromethanesulfonate, triphenylsulfonium p-toluenesulfonate, (p-tert-butoxyphenyl)diphenylsulfonium p-toluenesulfonate, bis(p-tert-butoxyphenyl)phenylsulfonium p-toluenesulfonate, tris(p-tert-butoxyphenyl)sulfonium p-toluenesulfonate, triphenylsulfonium nonafluorobutanesulfonate, trimethyl-sulfonium trifluoromethanesulfonate, cyclohexylmethyl(2-oxocyclohexyl)sulfonium trifluoromethanesulfonate, cyclo-hexylmethyl(2-oxocyclohexyl)sulfonium p-toluenesulfonate, dimethylphenylsulfonium trifluoromethanesulfonate, di-methylphenylsulfonium p-toluenesulfonate, dicyclohexyl-phenylsulfonium trifluoromethanesulfonate, dicyclohexyl-phenylsulfonium p-toluenesulfonate, trinaphthylsulfonium trifluoromethanesulfonate, cyclohexylmethyl(2-oxocyclohexyl)sulfonium trifluoromethanesulfonate, (2-norbornyl)-methyl(2-oxocyclohexyl)sulfonium trifluoromethanesulfonate, ethylenebis[methyl(2-oxocyclopentyl)sulfonium trifluoro-methanesulfonate] and 1,2′-naphthylcarbonylmethyltetra-hydrothiophenium triflate; diazomethane derivatives such as bis(benzenesulfonyl)diazomethane, bis(p-toluenesulfonyl)diazomethane, bis(xylenesulfonyl)diazomethane, bis(cyclo-hexylsulfonyl)diazomethane, bis(cyclopentylsulfonyl)diazomethane, bis(n-butylsulfonyl)diazomethane, bis(isobutyl-sulfonyl)diazomethane, bis(sec-butylsulfonyl)diazomethane, bis(n-propylsulfonyl)diazomethane, bis(isopropylsulfonyl)-diazomethane, bis(tert-butylsulfonyl)diazomethane, bis(n-amylsulfonyl)diazomethane, bis(isoamylsulfonyl)diazomethane, bis(sec-amylsulfonyl)diazomethane, bis(tert-amylsulfonyl)-diazomethane, 1-cyclohexylsulfonyl-1-(tert-butylsulfonyl)-diazomethane, 1-cyclohexylsulfonyl-1-(tert-amylsulfonyl)-diazomethane and 1-tert-amylsulfonyl-1-(tert-butyl-sulfonyl)diazomethane; glyoxime derivatives such as bis-O-(p-toluenesulfonyl)-α-dimethylglyoxime, bis-O-(p-toluenesulfonyl)-α-diphenylglyoxime, bis-O-(p-toluene-sulfonyl)-α-dicyclohexylglyoxime, bis-O-(p-toluene-sulfonyl)-2,3-pentanedioneglyoxime, bis-O-(p-toluene-sulfonyl)-2-methyl-3,4-pentanedioneglyoxime, bis-O-(n-butanesulfonyl)-α-dimethylglyoxime, bis-O-(n-butane-sulfonyl)-α-diphenylglyoxime, bis-O-(n-butanesulfonyl)-(1-dicyclohexylglyoxime, bis-O-(n-butanesulfonyl)-2,3-pentanedioneglyoxime, bis-O-(n-butanesulfonyl)-2-methyl-3,4-pentanedioneglyoxime, bis-O-(methanesulfonyl)-α-dimethylglyoxime, bis-O-(trifluoromethanesulfonyl)-α-dimethylglyoxime, bis-O-(1,1,1-trifluoroethanesulfonyl)-α-dimethylglyoxime, bis-O-(tert-butanesulfonyl)-α-dimethylglyoxime, bis-O-(perfluorooctanesulfonyl-α-dimethylglyoxime, bis-O-(cyclohexanesulfonyl)-α-dimethylglyoxime, bis-O-(benzenesulfonyl)-α-dimethylglyoxime, bis-O-(p-fluorobenzenesulfonyl)-α-dimethylglyoxime, bis-O-(p-tert-butylbenzenesulfonyl)-α-dimethylglyoxime, bis-O-(xylene-sulfonyl)-α-dimethylglyoxime and bis-O-(camphorsulfonyl)-α-dimethylglyoxime; β-ketosulfone derivatives such as 2-cyclohexylcarbonyl-2-(p-toluenesulfonyl)propane and 2-isopropylcarbonyl-2-(p-toluenesulfonyl)propane; disulfone derivatives such as diphenyldisulfone and dicyclohexyl-disulfone; nitrobenzylsulfonates such as 2,6-dinitrobenzyl p-toluenesulfonate and 2,4-dinitrobenzyl p-toluenesulfonate; sulfonic ester derivatives such as 1,2,3-tris(methanesulfonyloxy)benzene, 1,2,3-tris(trifluoromethanesulfonyloxy)benzene and 1,2,3-tris(p-toluenesulfonyloxy)benzene; imidoylsulfonate derivatives such as phthalimidoyl triflate, phthalimidoyl tosylate, 5-norbornene-2,3-dicarboxyimidoyl triflate, 5-norbornene-2,3-dicarboxyimidoyl tosylate and 5-norbornene-2,3-dicarboxyimidoyl n-butyltrifresulfonate; and the like. Preferably used are onium salts such as triphenylsulfonium trifluoromethanesulfonate, (p-tert-butoxyphenyl)diphenylsulfonium trifluoromethanesulfonate, tris(p-tert-butoxyphenyl)sulfonium trifluoromethanesulfonate, triphenylsulfonium p-toluenesulfonate, (p-tert-butoxyphenyl)diphenylsulfonium p-toluenesulfonate, tris(p-tert-butoxyphenyl)sulfonium p-toluenesulfonate, trinaphthylsulfonium trifluoromethanesulfonate, cyclo-hexylmethyl(2-oxocyclohexyl)sulfonium trifluoromethanesulfonate, (2-norbornyl)methyl(2-oxocyclohexyl)sulfonium trifluoromethanesulfonate, and 1,2′-naphthylcarbonyl-methyltetrahydrothiophenium triflate; diazomethane derivatives such as bis(benzenesulfonyl)diazomethane, bis-(p-toluenesulfonyl)diazomethane, bis(cyclohexylsulfonyl)-diazomethane, bis(n-butylsulfonyl)diazomethane, bis(iso-butylsulfonyl)diazomethane, bis(sec-butylsulfonyl)diazomethane, bis(n-propylsulfonyl)diazomethane, bis(isopropyl-sulfonyl)diazomethane and bis(tert-butylsulfonyl)-diazomethane; and glyoxime derivatives such as bis-O-(p-toluenesulfonyl)-α-dimethylglyoxime and bis-O-(n-butanesulfonyl)-α-dimethylglyoxime. The above-mentioned acid generators can be used either singly or as a combination of two or more thereof. The onium salts are excellent in the effect of improving rectangularity, and the diazomethane derivatives and the glyoxime derivatives are excellent in the effect of decreasing standing waves. It is therefore possible to finely adjust a profile by combining both.

The amount of the acid generator assed is preferably from 0.2 to 15 parts per 100 pars of the base resin. Less than 0.2 part results in a decreased amount of the acid generated on exposure, and in inferior sensitivity and resolving properties in some cases. On the other hand, exceeding 15 parts results in reduced transparency and in lowered resolving properties in some cases.

As the basic compound, a compound which can inhibit the rate of diffusion at the time when the acid generated from the acid generator diffuses into a resist film is suitable. Blending of such a basic compound inhibits the rate of diffusion of the acid in the resist film to improve resolution, which inhibits changes in sensitivity after exposure or reduces the substrate or environmental dependency, thereby being able to improve the degree of exposure flexibility, the pattern profile or the like

Such basic compounds include ammonia, primary, secondary and tertiary aliphatic amines, a mixed amine, an aromatic amine, a heterocyclic amine, a nitrogen-containing compound having a carboxyl group, a nitrogen-containing compound having a sulfonyl group, a nitrogen-containing compound having a hydroxyl group, a nitrogen-containing compound having a hydroxyphenyl group, an alcoholic nitrogen-containing compound, an amide derivative, an imide derivative and the like.

Specific examples of the primary amines include methylamine, ethylamine, n-propylamine, isopropylamine, n-butylamine, isobutylamine, sec-butylamine, tert-butylamine, pentylamine, tert-amylamine, cyclopentylamine, hexylamine, cyclohexylamine, heptylamine, octylamine, nonylamine, decylamine, dodecylamine, acetylamine, methylenediamine, ethylenediamine, tetraethylenepentamine and the like.

Specific examples of the secondary amines include dimethylamine, diethylamine, di-n-propylamine, diiso-propylamine, di-n-butylamine, diisobutylamine, di-sec-butylamine, dipentylamine, dicyclopentylamine, dihexylamine, dicyclohexylamine, diheptylamine, dioctylamine, dinonylamine, didecylamine, didodecylamine, dicetylamine, N,N-dimethylmethylenediamine, N,N-dimethylethylenediamine, N,N-di-methyltetraethylenepentamine and the like.

Specific examples of the tertiary amines include trimethylamine, triethylamine, tri-n-propylamine, triiso-propylamine, tri-n-butylamine, triisobutylamine, tri-sec-butylamine, tripentylamine, tricyclopentylamine, trihexyl-amine, tricyclohexylamine, triheptylamine, trioctylamine, trinonylamine, tridecylamine, tridodecylamine, tricetylamine, N,N,N′,N′-tetramethylmethylenediamine, N,N,N′,N′-tetramethylethylenediamine, N,N,N′,N′-tetramethyltetraethylenepentamine and the like.

Specific examples of the mixed amines include dimethylethylamine, methylethylpropylamine, benzylamine, phenetylamine, benzyldimethylamine and the like.

Specific examples of the aromatic amines include aniline derivatives such as aniline, N-methylaniline, N-ethylaniline, N-propylaniline, N,N-dimethylaniline, 2-methylaniline, 3-methylaniline, 4-methylaniline, ethylaniline, propylaniline, trimethylaniline, 2-nitroaniline, 3-nitroaniline, 4-nitroaniline, 2,4-dinitroaniline, 2,6-dinitroaniline, 3,5-dinitroaniline and N,N-dimethyltoluidine, diphenyl(p-tolyl)amine, methyldiphenylamine, triphenylamine, phenylenediamine, naphthylamine, diaminonaphthalene and the like.

Specific examples of the heterocyclic amines include pyrrole derivatives such as pyrrole, 2H-pyrrole, 1-methylpyrrole, 2,4-dimethylpyrrole, 2,5-dimethylpyrrole and N-methylpyrrole; oxazole derivatives such as oxazole and isooxazole; thiazole derivatives such as thiazole and isothiazole; imidazole derivatives such as imidazole, 4-methylimidazole and 4-methyl-2-phenylimidazole; pyrazole derivatives; furazane derivatives; pyrroline derivatives such as pyrroline and 2-methyl-1-pyrroline; pyrrolidine derivatives such as pyrrolidine, N-methylpyrrolidine, pyrrolidinone and N-methylpyrrolidone; imidazoline derivatives; imidazolidine derivatives; pyridine derivatives such as pyridine, methylpyridine, ethylpyridine, propylpyridine, butylpyridine, 4-(1-butylpentyl)pyridine, dimethylpyridine, trimethylpyridine, triethylpyridine, phenylpyridine, 3-methyl-2-phenylpyridine, 4-tert-butylpyridine, diphenylpyridine, benzylpyridine, methoxypyridine, butoxypyridine, dimethoxypyridine, 1-methyl-2-pyridine, 4-pyrolidinopyridine, 1-methyl-4-phenylpyridine, 2-(1-ethyl-propyl)pyridine, aminopyridine and dimethylaminopyridine; pyridazine derivatives; pyrimidine derivatives; pyrazine derivatives; pyrazoline derivatives; pyrazolidine derivatives; piperidine derivatives, piperadine derivatives; morpholine derivatives; indole derivatives; isoindole derivatives; 1H-indazole derivatives; indoline derivatives; quinoline derivatives such as quinoline and 3-quinolinecarbonitrile; isoquinoline derivatives; cinnoline derivatives; quinazoline derivatives; quinoxaline derivatives; phthalazine derivatives; purine derivatives; pterizine derivatives; carbazole derivatives; phenanthridine derivatives; acridine derivatives; phenazine derivatives; 1,10-phenanthroline derivatives; adenine derivatives; adenosine derivatives; guanine derivatives; guanosine derivatives; uracil derivatives; uridine derivatives; and the like.

Specific examples of the nitrogen-containing compounds having a carboxyl group include amino acid derivatives such as alanine, arginine, aspartic acid, glutamic acid, glycine, histidine, isoleucine, glycylleucine, leucine, methionine, phenylalanine, threonine, lysine 3-aminopyrazine-2-carboxylic acid and methoxyalanine, as well as aminobenzoic acid, indolecarboxylic acid and nicotinic acid. Specific examples of the nitrogen-containing compounds having a sulfonyl group include 3-pyridinesulufonic acid, pyridinium p-toluenesulfonate and the like.

Specific examples of the nitrogen-containing compounds having a hydroxyl group, nitrogen-containing compounds having a hydroxyphenyl group and the alcoholic nitrogen-containing compounds include 2-hydroxypyridine, aminocresol, 2,4-quinolinediol, 3-indolemethanol hydrate, monoethanolamine, diethanolamine, triethanolamine, N-ethyldiethanolamine, N,N-diethylethanolamine, triisopropanolamine, 2,2′-iminodiethanol, 2-aminoethanol, 3-amino-1-propanol, 4-amino-1-butanol, 4-(2-hydroxyethyl)morpholine 2-(2-hydroxyethyl)pyridine, 1-(2-hydroxyethyl)piperidine, 1-[2-(2-hydroxyethoxy)ethyl]piperidine, piperidineethanol, 1-(2-hydroxyethyl)pyrrolidine 1-(2-hydroxyethyl)-2-pyrrolidinone, 3-piperidino-1,2-propandiol, 3-pyrrolidino-1,2-propandiol, 8-hydroxyjulolidine, 3-quinuclidinol, 3-tropanol, 1-methyl-2-pyrrolidineethanol, 1-aziridineethanol, N-(2-hydroxyethyl)phthalimide, N-(2-hydroxyethyl)isonicotinamide and the like.

Specific examples of the amide derivatives include formamide, N-methylformamide, N,N-dimethylformamide, acetamide, N-methylacetamide, N,N-dimethylacetamide, propionamide, benzamide and the like.

Specific examples of the imide derivatives include phthalimide, succinimide, maleimide and the like.

Specific examples of the basic compounds other than the above include tris(2-methoxymethoxyethyl)amine, tris{2-(2-methoxyethoxy)ethyl}amine, tris{2-(2-methoxyethoxymethoxy)ethyl}amine, tris{2-(1-methoxyethoxy)ethyl}amine, tris{2-(1-ethoxyethoxy)ethyl}amine, tris{2-(1-ethoxy-propoxy)ethyl}amine, tris[2-{2-(2-hydroxyethoxy)ethoxy}-ethyl}amine, 4,7,13,16,21,24-hexaoxa-1,10-diazabicyclo-[8.8.8]hexacosane, 4,7,13,18-tetraoxa-1,10-diazabicyclo-[8.5.5]eicosane, 1,4,10,13-tetraoxa-7,16-diazabicycloocta-decane, 1-aza-12-crown-4,1-aza-15-crown-5,1-aza-18-crown-6, tris(2-formyloxyethyl)amine, tris(2-formyloxyethyl)amine, tris(2-acetoxyethyl)amine, tris(2-propyonyloxyethyl)amine, tris(2-butyryloxyethyl)amine, tris(2-isobutyryloxyethyl)amine, tris(2-valeryloxyethyl)amine, tris(2-pivaloyloxyxyethyl)amine, N,N-bis(2-acetoxyethyl)2-(acetoxyacetoxy)ethylamine, tris(2-methoxycarbonyloxyethyl)amine, tris(2-tert-butoxycarbonyloxyethyl)amine, tris[2-(2-oxopropoxy)-ethyl]amine, tris[2-(methoxycarbonylmethyl)oxyethyl]amine, tris[2-(tert-butoxycarbonylmethyloxy)ethyl]amine, tris[2-(cyclohexyloxycarbonylmethyloxy)ethyl]amine, tris(2-meth-oxycarbonylethyl)amine, tris(2-ethoxycarbonylethyl)amine, N,N-bis(2-hydroxyethyl)2-(methoxycarbonyl)ethylamine, N,N-bis(2-acetoxyethyl)2-(methoxycarbonyl)ethylamine, N,N-bis(2-hydroxyethyl)2-(ethoxycarbonyl)ethylamine, N,N-bis(2-acetoxyethyl)2-(ethoxycarbonyl)ethylamine, N,N-bis-(2-hydroxyethyl)2-(2-methoxyethoxycarbonyl)ethylamine, N,N-bis(2-acetoxyethyl)2-(2-methoxyethoxycarbonyl)ethylamine, N,N-bis(2-hydroxyethyl)2-(2-hydroxyethoxycarbonyl)ethylamine, N,N-bis(2-acetoxyethyl)2-(2-acetoxyethoxycarbonyl)ethylamine, N,N-bis(2-hydroxyethyl)2-[(methoxycarbonyl)methoxycarbonyl]ethylamine, N,N-bis(2-acetoxy-ethyl)₂-[(methoxycarbonyl)methoxycarbonyl]ethylamine, N,N-bis (2-hydroxyethyl)2-(2-oxopropoxycarbonyl)ethylamine, N,N-bis(2-acetoxyethyl)2-(2-oxopropoxycarbonyl)ethylamine, N,N-bis(2-hydroxyethyl)2-(tetrahydrofurfuryloxycarbonyl)ethylamine, N,N-bis(2-acetoxyethyl)2-(tetrahydrofurfuryloxycarbonyl)ethylamine, N,N-bis(2-hydroxyethyl)2-[(2-oxotetrahydrofuran-3-yl)oxycarbonyl]ethylamine, N,N-bis(2-acetoxyethyl)2-[(2-oxotetrahydrofuran-3-yl)oxycarbonyl]ethylamine, N,N-bis(2-hydroxyethyl)2-(4-hydroxybutoxycarbonyl)ethylamine, N,N-bis(2-formyloxyethyl)2-(4-formyl-oxybutoxycarbonyl)ethylamine, N,N-bis(2-formyloxyethyl)2-(2-formyloxyethoxycarbonyl)ethylamine, N,N-bis(2-methoxy-ethyl)₂-(methoxycarbonyl)ethylamine, N-(2-hydroxyethyl)-bis[2-(methoxycarbonyl)ethyl]amine, N-(2-acetoxyethyl)bis-[2-(methoxycarbonyl)ethyl]amine, N-(2-hydroxyethyl)bis[2-(ethoxycarbonyl)ethyl]amine, N-(2-acetoxyethyl)bis[2-(ethoxycarbonyl)ethyl]amine, N-(3-hydroxy-1-propyl)bis[2-(methoxycarbonyl)ethyl]amine, N-(3-acetoxy-1-propyl)bis[2-(methoxycarbonyl)ethyl]amine, N-(2-methoxyethyl)bis[2-(methoxycarbonyl)ethyl]amine, N-butylbis[2-(methoxycarbonyl)ethyl]amine, N-butylbis[2-(2-methoxyethoxy-carbonyl)ethyl]amine, N-methylbis(2-acetoxyethyl)amine, N-ethylbis(2-acetoxyethyl)amine, N-methylbis(2-pivaloyl-oxyxyethyl)amine, N-ethylbis[2-(methoxycarbonyloxy)ethyl]-amine, N-ethylbis[2-(tert-butoxycarbonyloxy)ethyl]amine, tris(methoxycarbonylmethyl)amine, tris(ethoxycarbonyl-methyl)amine, N-butylbis(methoxycarbonylmethyl)amine, N-hexylbis (methoxycarbonylmethyl)amine, β-(diethylamino)-6-valerolactone, 1-[2-(methoxymethoxy)ethyl]pyrrolidine, 1-[2-(methoxymethoxy)ethyl]piperidine, 4-[2-(methoxy-methoxy)ethyl]morpholine, 1-[2-[(2-methoxyethoxy)methoxy]-ethyl]pyrrolidine, 1-[2-[(2-methoxyethoxy)methoxy]ethyl]-piperidine, 4-[2-[(2-methoxyethoxy)methoxy]ethyl]morpholine, 2-(1-pyrrolidinyl)ethyl acetate, 2-piperidinoethyl acetate, 2-morpholinoethyl acetate, 2-(1-pyrrolidinyl)ethyl formate, 2-piperidinoethyl propionate, 2-morpholinoethyl acetoxy-acetate, 2-(1-pyrrolidinyl)ethyl methoxyacetate, 4-[2-(methoxycarbonyloxy)ethylmorpholine, 1-(2-(t-butoxy-carbonyloxy)ethyl]piperidine, 4-[2-(methoxyethoxycarbonyl-oxy)ethyl]morpholine, methyl 3-(1-pyrrolidinyl)propionate, methyl 3-piperidinopropionate, methyl 3-morpholinopropionate, methyl 3-(thiomorpholino)propionate, methyl 2-methyl-3-(1-pyrrolidinyl)propionate, ethyl 3-morpholinopropionate, methoxycarbonylmethyl 3-piperidinopropionate, 2-hydroxyethyl 3-(1-pyrrolidinyl)propionate, 2-acetoxyethyl 3-morpholinopropionate, 2-oxotetrahydrofuran-3-yl 3-(1-pyrrolidinyl)propionate, tetrahydrofurfuryl 3-morpholino-propionate, glycidyl 3-piperidinopropionate, 2-methoxyethyl 3-morpholinopropionate, 2-(2-methoxyethoxy)ethyl 3-(1-pyrrolidinyl)propionate, butyl 3-morphonopropionate, cyclohexyl 3-piperidinopropionate, α-(1-pyrrolidinyl)methyl-γ-butyrolactone, β-piperidino-γ-butyrolactone, β-morpholino-δ-valerolactone, methyl 1-pyrrolidinylacetate, methyl piperidinoacetate, methyl morpholinoacetate, methyl thiomorpholinoacetate, ethyl 1-pyrrolidinylacetate, 2-methoxyethyl morpholinoacetate and the like.

Further, a cyano group-containing basic compound can be added. Examples thereof include 3-(diethylamino)propiononitrile, N,N-bis(2-hydroxyethyl)-3-aminopropiononitrile, N,N-bis(2-acetoxyethyl)-3-aminopropiononitrile, N,N-bis(2-formyloxyethyl)-3-aminopropiononitrile, N,N-bis(2-methoxyethyl)-3-aminopropiononitrile, N,N-bis[(2-methoxymethoxy)ethyl]-3-aminopropiononitrile, methyl N-(2-cyanoethyl)-N-(2-methoxyethyl)-3-aminopropionate, methyl N-(2-acetoxyethyl)-N-(2-cyanoethyl)-3-aminopropionate, N-(2-cyanoethyl)-N-ethyl-3-aminopropiononitrile, N-(2-cyano-ethyl)-N-(2-hydroxyethyl)-3-aminopropiononitrile, N-(2-acetoxyethyl)-N-(2-cyanoethyl)-3-aminopropiononitrile, N-(2-cyanoethyl)-N-(2-formyloxyethyl)-3-aminopropiononitrile, N-(2-cyanoethyl)-N-(2-methoxyethyl)-3-aminopropiononitrile, N-(2-cyanoethyl)-N-[2-(methoxymethoxy)ethyl]-3-aminopropiononitrile, N-(2-cyanoethyl)-N-(3-hydroxy-1-propyl)-3-aminopropiononitrile, N-(3-acetoxy-1-propyl)-N-(2-cyanoethyl)-3-aminopropiononitrile, N-(2-cyanoethyl)-N-(3-formyloxy-1-propyl)-3-aminopropiononitrile, N-(2-cyano-ethyl)-N-tetrahydrofurfuryl-3-aminopropiononitrile, N,N-bis(2-cyanoethyl)-3-aminopropiononitrile, diethylaminoacetonitrile, N,N-bis(2-hydroxyethyl)aminoacetonitrile, N,N-bis(2-acetoxyethyl)aminoacetonitrile, N,N-bis(2-formyloxyethyl)aminoacetonitrile, N,N-bis(2-methoxyethyl)-aminoacetonitrile, N,N-bis[2-(methoxymethoxy)ethyl]aminoacetonitrile, methyl N-cyanomethyl-N-(2-methoxyethyl)-3-aminopropionate, methyl N-cyanomethyl-N-(2-hydroxyethyl)-3-aminopropionate, methyl N-(2-acetoxyethyl)-N-cyano-methyl-3-aminopropionate, N-cyanomethyl-N-(2-hydroxy-ethyl)aminoacetonitrile, N-(2-acetoxyethyl)-N-(cyano-methyl)aminoacetonitrile, N-cyanomethyl-N-(2-methoxy-ethyl)aminoacetonitrile, N-cyanomethyl-N-[2-(methoxy-methoxy)ethyl]aminoacetonitrile, N-(cyanomethyl)-N-(3-hydroxy-1-propyl)aminoacetonitrile, N-(3-acetoxy-1-propyl)-N-(cyanomethyl)aminoacetonitrile, N-cyanomethyl-N-(3-formyloxy-1-propyl)aminoacetonitrile, N,N-bis(cyano-methyl)aminoacetonitrile, 1-pyrrolidinepropiononitrile, 1-piperidinepropiononitrile, 4-morpholinepropiononitrile, 1-pyrrolidineacetonitrile, 1-piperidineacetonitrile, 4-morpholineacetonitrile, cyanomethyl 3-diethylaminopropionate, cyanomethyl N,N-bis(2-hydroxyethyl)-3-aminopropionate, cyanomethyl N,N-bis(2-acetoxyethyl)-3-aminopropionate, cyanomethyl N,N-bis(2-formyloxyethyl)-3-aminopropionate, cyanomethyl N,N-bis[2-(methoxymethoxy)ethyl]-3-aminopropionate, (2-cyanoethyl) 3-diethylaminopropionate, (2-cyanoethyl) N,N-bis(2-hydroxyethyl)-3-aminopropionate, (2-cyanoethyl) N,N-bis(2-formyloxyethyl)-3-aminopropionate, (2-cyanoethyl) N,N-bis(2-methoxyethyl)-3-aminopropionate, (2-cyanoethyl) N,N-bis[2-(methoxymethoxy)ethyl]-3-aminopropionate, cyanomethyl 1-pyrrolidinepropionate, cyanomethyl 1-piperidinepropionate, cyanomethyl 4-morpholinepropionate, (2-cyanoethyl) 1-pyrrolidinepropionate, (2-cyanoethyl) 1-piperidinepropionate and (2-cyanoethyl) 4-morpholine-propionate.

The basic compounds can be used either singly or as a combination of two or more thereof. The amount thereof blended is suitably from 0.01 to 2 parts, and particularly suitably from 0.01 to 1 part, per 100 parts of the whole base resin. When the amount blended is less than 0.01 part, the effect as the additive is not sufficiently obtained in some cases. On the other hand, exceeding 2 parts results in reduced resolution and sensitivity in some cases.

The dissolution inhibitor is a compound whose solubility in an alkaline aqueous solution varies by the action of the acid, i.e., a compound having an acid-labile group, and can be used without any particular limitation on its structure. As the general acid-labile group, there is used the acid-labile group described above, which is a functional group severed with the acid. The polymer compound in which such an acid-labile group is used is insoluble or slightly soluble in an alkaline aqueous solution before irradiation of an active energy ray, and hydrolyzed with the acid generated from the acid generator by irradiation of the active energy ray, resulting in showing solubility in the alkaline aqueous solution.

As the dissolution inhibitor, suitably used is a compound having a molecular weight of 3,000 or less whose solubility in a developing solution varies by the action of the acid. Particularly, a phenol, carboxylic acid derivative or hexafluoroisopropanol-containing compound having a molecular weight of 2,500 or less whose hydroxyl groups are partially or fully substituted by the acid-labile groups is suitable. Examples thereof include 3,3′,5,5′-tetrafluoro[(1,1′-biphenyl)-4,4′-di-tert-butoxycarbonyl], 4,4′-[2,2,2-trifluoro-1-(trifluoromethyl)ethylidene]bisphenol-4,4′-di-tert-butoxycarbonyl, bis(4-(2′-tetrahydropyranyloxy)phenyl)-methane, bis(4-(2′-tetrahydrofuranyloxy)phenyl)methane, bis(4-tert-butoxyphenyl)methane, bis(4-tert-butoxy-carbonyloxyphenyl)methane, bis(4-tert-butoxycarbonyl-methyloxyphenyl)methane, bis(4-(1′-ethoxyethoxy)phenyl)-methane, bis(4-(1′-ethoxypropyloxy)phenyl)methane, 2,2-bis(4′-(2″-tetrahydropyranyloxy))propane, 2,2-bis(4′-(2″-tetrahydrofuranyloxy)phenyl)propane, 2,2-bis(4′-tert-butoxyphenyl)propane, 2,2-bis(4′-tert-butoxycarbonyloxy-phenyl)propane, 2,2-bis(4-tert-butoxycarbonylmethyloxy-phenyl)propane, 2,2-bis(4′-(1″-ethoxyethoxy)phenyl)propane, 2,2-bis(4′-(1″-ethoxypropyloxy)phenyl)propane, tert-butyl 4,4-bis(4′-(2″-tetrahydropyranyloxy)phenyl)valerate, tert-butyl 4,4-bis(4′-(2″-tetrahydrofuranyloxy)phenyl)valerate, tert-butyl 4,4-bis(4′-tert-butoxyphenyl)valerate, tert-butyl 4,4-bis(4-tert-butoxycarbonyloxyphenyl)valerate, tert-butyl 4,4-bis(4′-tert-butoxycarbonylmethyloxyphenyl)-valerate, tert-butyl 4,4-bis(4′-(1″-ethoxyethoxy)phenyl)-valerate, tert-butyl 4,4-bis(4′-(1″-ethoxypropyloxy)-phenyl)valerate, tris(4-(2′-tetrahydropyranyloxy)phenyl)-methane, tris(4-(2′-tetrahydrofuranyloxy)phenyl)methane, tris(4-tert-butoxyphenyl)methane, tris(4-tert-butoxy-carbonyloxyphenyl)methane, tris(4-tert-butoxycarbonyloxy-methylphenyl)methane, tris(4-(1′-ethoxyethoxy)phenyl)-methane, tris(4-(1′-ethoxypropyloxy)phenyl)methane, 1,1,2-tris(4′-(2″-tetrahydropyranyloxy)phenyl)ethane, 1,1,2-tris(4′-(2″-tetrahydrofuranyloxy)phenyl)ethane, 1,1,2-tris(4′-tert-butoxyphenyl)ethane, 1,1,2-tris(4′-tert-butoxycarbonyloxyphenyl)ethane, 1,1,2-tris(4′-tert-butoxycarbonylmethyloxyphenyl)ethane, 1,1,2-tris(4′-(1′-ethoxyethoxy)phenyl)ethane, 1,1,2-tris(4′-(1′-ethoxy-propyloxy)phenyl)ethane, 1,1-tert-butyl 2-trifluoromethyl-benzenecarboxylate, tert-butyl 2-trifluoromethylcyclo-hexanecarboxylate, tert-butyl decahydronaphthalene-2,6-dicarboxylate, tert-butyl cholate, tert-butyl deoxycholate, tert-butyl adamantanecarboxylate, tert-butyl adamantaneacetate, tetra-tert-butyl 1,1′-bicyclohexyl-3,3′,4,4′-tetracarboxylate and the like.

The amount of the dissolution inhibitor added to the resist composition of the invention is 20 parts or less, and preferably 15 parts or less, per 100 parts of the base resin in the resist composition. Exceeding 20 parts results in reduced heat resistance of the resist composition.

In addition to the above-mentioned components, a surfactant in common use for improving coating properties can be added as an optional component to the resist composition of the invention. The amount of the additives added can be an ordinary amount within the range that does not disturb the effect of the invention. The surfactants as used herein are preferably a nonionic one, and include a perfluoroalkyl polyoxyethylene ethanol, a fluorinated alkyl ester, a perfluoroalkylamine oxide, a perfluoroalkyl EO addition product, a fluorinated organosiloxane compound and the like. Examples thereof include Florard FC-430 and FC-431 (both manufactured by Sumitomo 3M Limited), Surflon S-141 and S-145 (both manufactured by Asahi Glass Co., Ltd.), Unidyne DS-401, DS-403 and DS-451 (all manufactured by Daikin Industries, Inc.), Megafac F-8151 (manufactured by Dainippon Ink & Chemicals, Inc.), X-70-092 and X-70-093 (both manufactured by Shin-Etsu Chemical Co., Ltd.) and the like. Preferred are Florard FC-430 (manufactured by Sumitomo 3M Limited) and X-70-093 (manufactured by Shin-Etsu Chemical Co., Ltd.).

In order to form a pattern using the resist composition of the invention, known lithography technique can be employed. For example, the resist composition is applied onto a substrate such as a silicon wafer by a technique such as spin coating to a film thickness of 0.1 to 1.0 μm, and pre-baked on a hot plate at 60 to 200° C. for 10 seconds to 10 minutes, preferably at 80 to 150° C. for 30 seconds to 5 minutes. Then, a mask for forming a desired pattern is placed on the above-mentioned resist film, and a high energy ray such as a far ultraviolet ray, an excimer laser beam or an X-ray, or an electron beam is irradiated thereon so as to give an exposure amount of about 1 to about 200 mJ/cm², preferably about 10 to about 100 mJ/cm². Then, heat treatment, i.e., post exposure bake (PEB) is performed on the hot plate at 60 to 150° C. for 10 seconds to 5 minutes, preferably at 80 to 130° C. for 30 seconds to 30 minutes. Further, using an alkaline aqueous solution of tetramethylammonium hydroxide (TMAH) as a developing solution, development is performed by a normal process such as a dip process, a puddle process or a spray process for 10 seconds to 3 minutes, preferably for 30 seconds to 2 minutes, thereby forming a desired pattern on the substrate. The material of the invention is most suitable for micropatterning particularly using an ultraviolet ray or excimer laser beam having a wavelength of 300 to 12 nm of the high energy rays, more particularly using a laser beam such as KrF of 248 nm, ArF of 193 nm, F2 of 157 nm, Kr₂ of 146 nm, KrAr of 143 nm, Ar₂ of 126 nm or EUV, or an X-ray.

### EXAMPLES

The present invention will be illustrated in greater detail with reference to the following Examples, but the invention should not be construed as being limited thereto.

### Comparative Example

Polymerization of Compound Represented by Structural Formula (6)

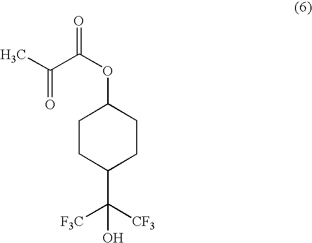

A three-necked flask equipped with a reflux condenser and a stirrer was charged with a compound (1.0 g) represented by structural formula (6), Perbutyl PV (4 mol %) as a polymerization initiator and methyl ethyl ketone (50 wt %) as a polymerization solvent. This flask was heated on an oil bath at 75° C. to conduct reaction for 15 hours. After the reaction, the reaction solution was poured into n-hexane, followed by stirring. The resulting precipitate was taken out by filtration, and dried under vacuum at 50° C. for 10 hours. A comparison of the glass transition temperature (Tg) of a homopolymer of the compound represented by structural formula (6) with that of a homopolymer of a compound represented by structural formula (7) showed that the glass transition temperature (Tg) of the homopolymer of the compound represented by structural formula (6) was considerably low, which caused failure to apply the ordinary bake temperature.

### Example 1

Synthesis of Compound Represented by Structural Formula (7)

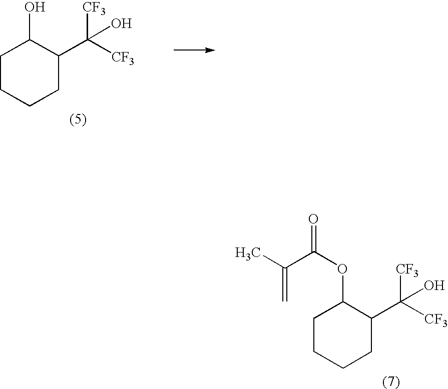

A four-necked flask equipped with a thermometer and a rotor was successively charged with a compound (230.36 g) represented by structural formula (5), toluene (1.2 L), methacrylic anhydride (146.77 g) and methanesulfonic acid (20.97 g), followed by stirring at an internal temperature of 85° C. for 2 hours. The reaction solution was poured into a saturated aqueous solution of sodium bicarbonate, and diluted with toluene to achieve two-layer separation. After washed with saturated brine, the organic layer was dried over anhydrous magnesium sulfate and filtered. The filtrate was concentrated with an evaporator. The residue was distilled under reduced pressure, and the resulting fraction was recrystallized from toluene to obtain a compound (241.79 g, 83%) represented by structural formula (7).

¹H-NMR (TMS, CDCl₃): 1.39 (m, 1H), 1.58 (m, 3H), 1.81 (q, 1H), 1.96 (t, 3H), 1.96 (m, 4H), 2.28 (d, 1H), 4.87 (s, 1), 5.47 (d, 1H), 5.64 (m, 1H), 6.16 (t, 1H)

¹⁹F-NMR (CClF, CDCl₃): −76.4 (q, 3H), −72.0 (q, 3H)

IR(cm⁻¹): 3370, 2995, 2958, 2932, 2854, 1699, 1636, 1214, 1187, 898

GC-MS (EI method): m/e 334 (M⁺), 316 (—H₂O), 265 (—CF₃)

### Example 2

Polymerization of Compound Represented by Structural Formula (7)

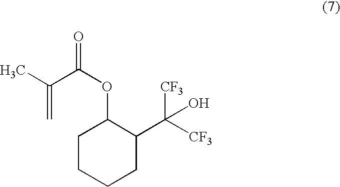

A three-necked flask equipped with a reflux condenser and a stirrer was charged with a compound (1.0 g) represented by structural formula (7), Perbutyl PV (4 mol %) as a polymerization initiator and methyl ethyl ketone (50 wt %) as a polymerization solvent. This flask was heated on an oil bath at 75° C. to conduct reaction for 15 hours. After the reaction, the reaction solution was poured into n-hexane, followed by stirring. The resulting precipitate was taken out by filtration, and dried under vacuum at 50° C. for 10 hours. The composition of the resulting polymer was determined from ¹H-NMR and ¹⁹F-NMR, the molecular weight (Mn, Mw/Mn) from GPC analysis (standard polystyrene), and the glass transition temperature (Tg) from DSC. The results thereof are shown in Table 1.

### Example 3

Copolymerization of Compound Represented by Structural Formula (7) and Compound Represented by Structural Formula (8)

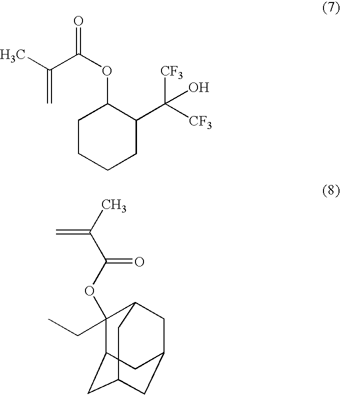

A flask was charged with the compound (0.84 g) represented by structural formula (7), a compound (0.16 g) represented by structural formula (8), Perbutyl PV (4 mol %) as a polymerization initiator and methyl ethyl ketone (100 wt %) as a polymerization solvent. This flask was heated on an oil bath at 75° C. to conduct reaction for 15 hours. After the reaction, the reaction solution was poured into n-hexane, followed by stirring. The resulting precipitate was taken out by filtration, and dried under vacuum at 50° C. for 10 hours. The results thereof are shown in Table 1.

### Example 4

Copolymerization of Compound Represented by Structural Formula (7), Compound Represented by Structural Formula (8) and Compound Represented by Structural Formula (9)

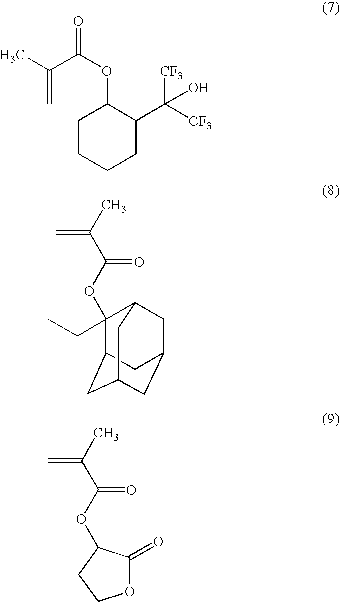

A flask was charged with the compound (0.46 g) represented by structural formula (7), the compound (0.26 g) represented by structural formula (8), a compound (0.17 g) represented by structural formula (9), Perbutyl PV (4 mol %) as a polymerization initiator and methyl ethyl ketone (100 wt %) as a polymerization solvent. This flask was heated on an oil bath at 75° C. to conduct reaction for 15 hours. After the reaction, the reaction solution was poured into n-hexane, followed by stirring. The resulting precipitate was taken out by filtration, and dried under vacuum at 50° C. for 10 hours. The results thereof are shown in Table 1.

### Example 5

Copolymerization of Compound Represented by Structural Formula (7), Compound Represented by Structural Formula (8) and Compound Represented by Structural Formula (10)

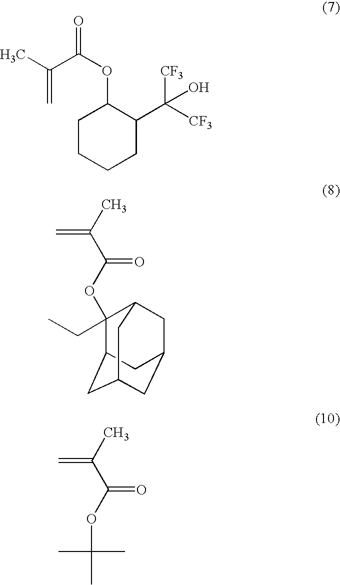

A flask was charged with the compound (0.54 g) represented by structural formula (7), the compound (0.24 g) represented by structural formula (8), a compound (0.22 g) represented by structural formula (10), Perbutyl PV (4 mol %) as a polymerization initiator and methyl ethyl ketone (100 wt %) as a polymerization solvent. This flask was heated on an oil bath at 75° C. to conduct reaction for 15 hours. After the reaction, the reaction solution was poured into n-hexane, followed by stirring. The resulting precipitate was taken out by filtration, and dried under vacuum at 50° C. for 10 hours. The results thereof are shown in Table 1.

### Example 6

Copolymerization of Compound Represented by Structural Formula (11), Compound Represented by Structural Formula (8) and Compound Represented by Structural Formula (9)

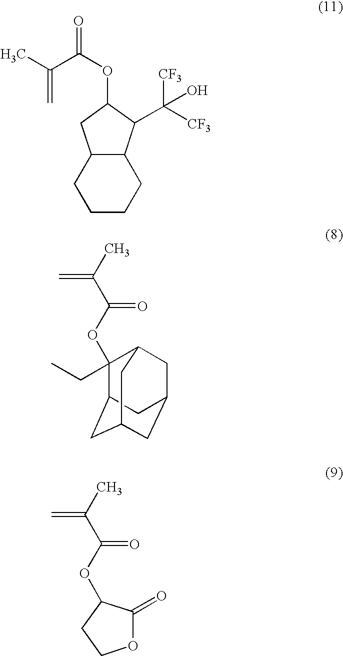

A flask was charged with a compound (0.38 g) represented by structural formula (11), the compound (0.41 g) represented by structural formula (8), the compound (0.21 g) represented by structural formula (9), Perbutyl PV (4 mol %) as a polymerization initiator and methyl ethyl ketone (100 wt %) as a polymerization solvent. This flask was heated on an oil bath at 75 to conduct reaction for 15 hours. After the reaction, the reaction solution was poured into n-hexane, followed by stirring. The resulting precipitate was taken out by filtration, and dried under vacuum at 50° C. for 10 hours. The results thereof are shown in Table 1.

### Example 7

Copolymerization of Compound Represented by Structural Formula (12), Compound Represented by Structural Formula (8) and Compound Represented by Structural Formula (9)

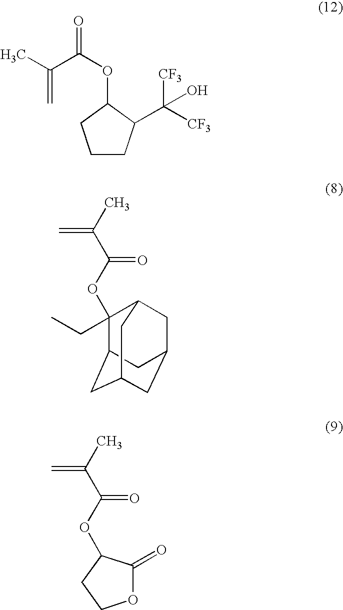

A flask was charged with a compound (0.30 g) represented by structural formula (12), the compound (0.48 g) represented by structural formula (8), the compound (0.22 g) represented by structural formula (9), Perbutyl PV (4 mol %) as a polymerization initiator and methyl ethyl ketone (100 wt %) as a polymerization solvent. This flask was heated on an oil bath at 75 to conduct reaction for 15 hours. After the reaction, the reaction solution was poured into n-hexane, followed by stirring. The resulting precipitate was taken out by filtration, and dried under vacuum at 50° C. for 10 hours. The results thereof are shown in Table 1.

### Example 8

Copolymerization of Compound Represented by Structural Formula (13), Compound Represented by Structural Formula (14) and Compound Represented by Structural Formula (15)

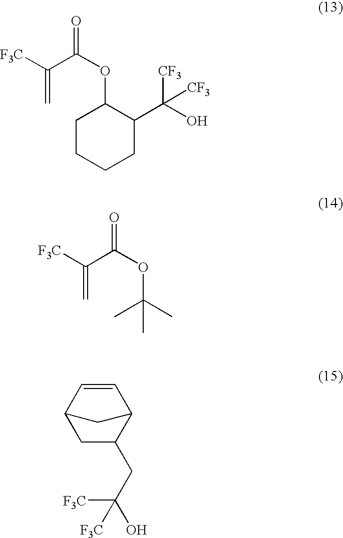

A flask was charged with a compound (0.48 g) represented by structural formula (13), a compound (0.18 g) represented by structural formula (14), a compound (0.36 g) represented by structural formula (15), Perbutyl PV (4 mol %) as a polymerization initiator and methyl ethyl ketone (100 wt %) as a polymerization solvent. This flask was heated on an oil bath at 75° C. to conduct reaction for 15 hours. After the reaction, the reaction solution was poured into n-hexane, followed by stirring. The resulting precipitate was taken out by filtration, and dried under vacuum at 50° C. for 10 hours. The results thereof are shown in Table 1.

TABLE 1

| | Yield | Polymer | | | |
|---|---|---|---|---|---|
| | (%) | Composition | Mn | Mw/Mn | Tg (° C.) |
| Example 2 | 76 | | 17000 | 2.8 | 164 |
| Example 3 | 31 | 7/8 = 83/17 | 15000 | 1.4 | >150 |
| Example 4 | 66 | 7/8/9 = 41/27/32 | 12000 | 2.3 | >150 |
| Example 5 | 28 | 7/8/10 = 43/21/36 | 15000 | 1.7 | >150 |
| Example 6 | 71 | 11/8/9 = 28/33/39 | 13000 | 1.9 | >150 |
| Example 7 | 75 | 12/8/9 = 28/33/39 | 12000 | 2.0 | >150 |
| Example 8 | 69 | 13/14/15 = 31/33/36 | 9800 | 1.4 | 134 |

Note: In “Polymer Composition”, the left side indicates the structural formula number of monomer compounds, and the right side indicates the molar ratios thereof.

In Examples 3 to 8, an ethyladamantyl group of structural formula (8) was eliminated at about 150° C. before reaching the glass transition temperature (Tg), so that it was impossible to measure the glass transition temperature (Tg), which is within the temperature range higher than 150° C.

### Example 9

Preparation and Evaluation of Resist Compositions and Patterns

The polymer compounds of Examples 3 to 8 were each dissolved in propylene glycol methyl acetate to give a solid content of 14%. Triphenylsulfonium triflate (TPS105) manufactured by Midori Kagaku Co., Ltd. was dissolved as an acid generator in an amount of 2 parts by weight per 100 parts by weight of each polymer compound to prepare two kinds of resist solutions. These resist solutions were applied by spin coating, and the light transmittance thereof at a film thickness of 100 nm was measured at a wavelength of 193 nm. As a result, it was 92%, 86%, 90%, 84%, 88% and 94% for Examples 3 to 8, respectively, and high transparency was exhibited at a wavelength in the vacuum ultraviolet region.

Then, all resist solutions were filtered through a membrane filter having a pore size of 0.2, and each composition solution was applied onto a silicon wafer by spin coating to obtain a resist film having a thickness of 250 nm. After pre-baked at 110° C., the resist film was exposed to a 248-nm ultraviolet ray through a photomask, followed by post exposure bake at 120° C. Then, development was performed at 23° C. for 1 minute using a 2.38-wt % tetramethylammonium hydroxide aqueous solution. As a result, pattern forms having no separation in the resist films and no development defects were obtained.

While the present invention has been described in detail and with reference to specific embodiments thereof, it will be apparent to one skilled in the art that various changes and modifications can be made therein without departing from the spirit and scope thereof.

The present application is based on Japanese Patent Application No. 2004-023157 filed on Jan. 30, 2004, the contents thereof being herein incorporated by reference.

1. A fluorine-containing acrylate compound represented by general formula (1): 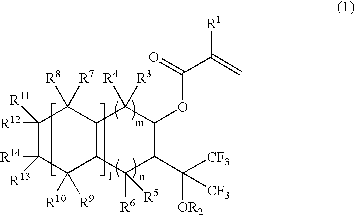
wherein R¹ is any one functional group of a hydrogen atom, a methyl group and a trifluoromethyl group; R² is a hydrogen atom or a straight-chain, branched or cyclic alkyl group having 1 to 25 carbon atoms, which may contain a fluorine atom, an oxygen atom, a nitrogen atom, a sulfur atom or a carbonyl bond at a part thereof; R³ to R¹⁴ are each a hydrogen atom or a straight-chain, branched or cyclic alkyl group having 1 to 25 carbon atoms, which may contain a fluorine atom, an oxygen atom, a nitrogen atom, a sulfur atom or a hydroxyl group at a part thereof; R³ and R⁵, R⁷ and R⁹, or two groups of R¹¹ to R¹⁴ may be combined with each other to form a ring as an alkylene group having 1 to 25 carbon atoms, which may contain an oxygen atom, a sulfur atom or a nitrogen atom at a part thereof; 1 is 0 or 1; and m and n each represents any integer of 0 to 4.

2. A fluorine-containing acrylate compound represented by general formula (2): 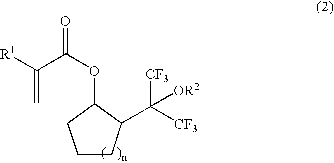
wherein R¹ is any one functional group of a hydrogen atom, a methyl group and a trifluoromethyl group; R² is a hydrogen atom or a straight-chain, branched or cyclic alkyl group having 1 to 25 carbon atoms, which may contain a fluorine atom, an oxygen atom, a nitrogen atom, a sulfur atom or a carbonyl bond at a part thereof; and n represents any integer of 0 to 8.

3. A fluorine-containing acrylate compound represented by general formula (3): 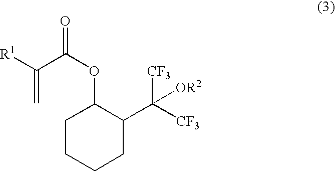
wherein R¹ is any one functional group of a hydrogen atom, a methyl group and a trifluoromethyl group; R² is a hydrogen atom or a functional group containing a straight-chain, branched or cyclic hydrocarbon group having 1 to 25 carbon atoms, which may contain a fluorine atom, an oxygen atom, a nitrogen atom, a sulfur atom or a carbonyl bond at a part thereof.

4. The fluorine-containing acrylate compound according to claim 1, wherein R² contains an acid-labile group.

5. A fluorine-containing acrylate compound represented by general formula (4): 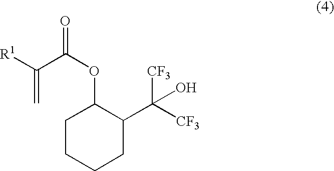
wherein R¹ is any one functional group of a hydrogen atom, a methyl group and a trifluoromethyl group.

6. A fluorine-containing polymer compound which is a polymer or a copolymer of the fluorine-containing acrylate compound according to claim 1.

7. The fluorine-containing polymer compound according to claim 6, which is a copolymer of a compound having an acid-labile group and the fluorine-containing acrylate compound.

8. The fluorine-containing polymer compound according to claim 6, which is a copolymer of a compound having a lactone structure and the fluorine-containing acrylate compound.

9. A resist composition containing the polymer compound according to claim 6.

10. A patterning process comprising the steps of:
applying the resist composition according to claim 9 onto a substrate,
conducting exposure to a high energy ray having a wavelength ranging from 1 to 300 nm through a photomask, and
performing developing treatment with a developing solution after heat treatment.

11. The patterning process according to claim 10, wherein the high energy ray is a KrF laser beam, an ArF laser beam, an F₂ laser beam, an EUV laser beam or an X-ray.

12. The fluorine-containing acrylate compound according to claim 2, wherein R² contains an acid-labile group.

13. The fluorine-containing acrylate compound according to claim 3, wherein R² contains an acid-labile group.

14. A fluorine-containing polymer compound which is a polymer or a copolymer of the fluorine-containing acrylate compound according to claim 2.

15. A fluorine-containing polymer compound which is a polymer or a copolymer of the fluorine-containing acrylate compound according to claim 3.

16. A fluorine-containing polymer compound which is a polymer or a copolymer of the fluorine-containing acrylate compound according to claim 4.

17. A fluorine-containing polymer compound which is a polymer or a copolymer of the fluorine-containing acrylate compound according to claim 5.
